(19) United States
(12) Patent Application Publication
(10) Pub. No.: US 2026/0163415 A1
(43) Pub. Date: Jun. 11, 2026

(54) ELECTRIC MOTOR HAVING LAMINAS-FORMED TEETH

(71) Applicant: Electric Torque Machines, Inc., Minneapolis, MN (US)

(72) Inventors: Tyler K. Williams, Flagstaff, AZ (US); Thomas F. Janecek, Flagstaff, AZ (US)

(21) Appl. No.: 19/180,891

(22) Filed: Apr. 16, 2025

Related U.S. Application Data
(63) Continuation of application No. 18/142,454, filed on May 2, 2023, now abandoned.
Application No. 18/142,454 is a continuation of application No. PCT/US22/14093, filed on Jan. 27, 2022.
(60) Provisional application No. 63/143,754, filed on Jan. 29, 2021.
(60) Provisional application No. 63/210,284, filed on Jun. 14, 2021.

(51) Int. Cl. H02K 1/16

(52) U.S. Cl. CPC H02K 1/16; H02K 2201/15

(57) ABSTRACT

An electric motor includes a rotor and a stator formed by a plurality of stator phases. The stator phases include coils that extend fully about the motor axis of the motor. The stator phases further include teeth arrayed around the motor axis. Each tooth has a tooth face oriented towards the rotor. Multiple of the lamina forming each tooth are exposed at the tooth face and are configured to extend axially and radially to the tooth face. The stator phases magnetically interact with the rotor to drive rotation of the rotor on the motor axis.

### CROSS-REFERENCE TO RELATED APPLICATION(S)

This application is a continuation of U.S. application Ser. No. 18/142,454 filed May 2, 2023 and entitled “ELECTRIC MOTOR HAVING LAMINAS-FORMED TEETH,” which in turn is a continuation of PCT International Application No. PCT/US22/14093 filed Jan. 27, 2022 for “ELECTRIC MOTOR HAVING LAMINAS-FORMED TEETH,” which in turn claims the benefit of U.S. Provisional Application No. 63/143,754 filed Jan. 29, 2021 and entitled “ELECTRIC MOTOR HAVING LAMINAS-FORMED TEETH,” and claims the benefit of U.S. Provisional Application No. 63/210,284 filed Jun. 14, 2021 and entitled “ELECTRIC MOTOR HAVING LAMINAS-FORMED TEETH,” the disclosures of which are hereby incorporated by reference in their entireties.

### BACKGROUND

The present disclosure relates generally to electric machines. More specifically, the present disclosure relates to transverse flux electric machines.

Electric motors utilize electricity to generate a mechanical output. Some electric motors generate rotational outputs. In alternating current (AC) induction motors, a stator is electrically energized to electromagnetically drive rotation of a rotor about a motor axis. The stator includes laminates and windings. The rotor includes permanent magnets that are acted on by the electromagnetic field induced by current through the stator to cause rotation of the rotor. Such electric motors include coils that extend axially relative to the rotational axis and that extend axially beyond the ends of the rotor to wrap around and form the ends of the coil windings.

### SUMMARY

According to an aspect of the disclosure, an electric motor including a rotor configured to rotate on an axis; and a stator configured to electromagnetically drive the rotor to rotate the rotor on the axis. The stator includes a first plurality of teeth. A first tooth of the first plurality of teeth is formed from a plurality of first lamina and includes a first tooth face oriented towards the rotor. Multiple first lamina of the plurality of first lamina include a terminus exposed at the first tooth face.

According to an additional or alternative aspect of the disclosure, an electric motor includes a rotor configured to rotate on an axis; a stator configured to electromagnetically drive the rotor to rotate the rotor on the axis, wherein the stator includes at least one phase assembly. The at least one phase assembly includes a first flux ring formed by a plurality of first lamina stacked together, the plurality of first lamina forming a plurality of first teeth of the first flux ring, wherein a first tooth of the plurality of first teeth includes a first tooth face oriented towards the rotor; a second flux ring formed by a plurality of second lamina stacked together, the plurality of second lamina forming a plurality of second teeth of the second flux ring, wherein a second tooth of the plurality of second teeth includes a second tooth face oriented towards the rotor; a plurality of axial returns extending between the first flux ring and the second flux ring; and a coil disposed axially between the first flux ring and the second flux ring, the coil disposed radially between the plurality of axial returns and the plurality of first teeth, and the coil disposed radially between the plurality of axial returns and the plurality of second teeth. The plurality of first lamina form the first tooth face. The plurality of second lamina form the second tooth face.

According to yet another additional or alternative aspect of the disclosure, a method of forming a flux ring for a stator of an electric motor includes forming a lamina with a sheet body extending partially about an axis between a first circumferential end and a second circumferential end and a plurality of tabs extending from a first radial side of the sheet body.

According to yet another additional or alternative aspect of the disclosure, a flux ring for an electric moor includes a plurality of lamina stacked together. Each lamina of the plurality of lamina includes a sheet body extending partially about an axis between a first circumferential end and a second circumferential end and a plurality of tabs extending from a first radial side of the sheet body. The plurality of lamina are stacked such that each lamina of the plurality of the lamina is indexed by one tab position relative to adjacent ones of the lamina of the plurality of lamina.

According to yet another additional or alternative aspect of the disclosure, a flux ring for an electric motor includes a ring body extending about an axis and a plurality of teeth extending from a radial side of the ring body, the ring body formed by a plurality of lamina stacked axially. A first lamina of the plurality of lamina has a first sheet body extending partially about the axis and a plurality of first tabs projecting from a first radial side of the first sheet body. A second lamina of the plurality of lamina has a second sheet body extending partially about the axis and a plurality of second tabs projecting from a second radial side of the second sheet body. The second lamina is disposed adjacent to the first lamina such that the second lamina and the first lamina axially overlap and the second lamina is offset circumferentially about the axis from the first lamina.

According to yet another additional or alternative aspect of the disclosure, a method of forming a laminate portion of a phase assembly of a stator of an electric motor, the phase assembly configured to be disposed coaxially on an axis with a rotor of the electric motor includes rolling a laminate strip into a laminate spool such that the laminate spool is formed by multiple layers of the laminate strip; forming a laminate rod from the laminate spool; and bending the laminate rod around a coil of the phase assembly such that the laminate rod is disposed on a first axial side of the coil, a second axial side of the coil opposite the first axial side, a first radial side of the coil; and a second radial side of the coil opposite the first radial side.

According to yet another additional or alternative aspect of the disclosure, a method of forming a flux ring for a stator of an electric motor includes forming a lamina as a flat plate having a sheet body extending about an axis and having a plurality of first tabs extending radially from the sheet body; bending each first tab of the plurality of first tabs to form a plurality of arms that project axially relative to the sheet body; and stacking a plurality of the lamina together such that the sheet bodies of the plurality of the lamina are stacked axially and such that the arms of the plurality of the lamina are stacked to form a plurality of teeth of the flux ring.

According to yet another additional or alternative aspect of the disclosure, a phase assembly of a stator of an electric motor includes a coil extending about an axis; and a first laminate rod formed from a plurality of stacked lamina and having a rod body, a first rod end, and a second rod end at an opposite end of the first laminate rod from the first rod end. The first laminate rod is wrapped around the coil such that the laminate rod is disposed on a first axial side of the coil, a second axial side of the coil opposite the first axial side, a first radial side of the coil; and a second radial side of the coil opposite the first radial side.

According to yet another additional or alternative aspect of the disclosure, a flux ring for a stator of an electric motor includes a plurality of first lamina stacked axially together to form a ring body extending about an axis; and a plurality of teeth extending axially relative to the ring body, wherein a first tooth of the plurality of teeth is formed by the plurality of first lamina. The plurality of first lamina are exposed at a tooth face of the first tooth.

According to yet another additional or alternative aspect of the disclosure, a phase assembly of a stator of an electric motor includes a coil extending about an axis; a first flux ring formed from a plurality of first lamina stacked together; a second flux ring formed from a plurality of second lamina stacked together; and a plurality of axial returns extending between the first flux ring and the second flux ring. A first axial return of the plurality of axial returns is formed by the plurality of first lamina and the plurality of second lamina.

### BRIEF DESCRIPTION OF THE DRAWINGS

FIG. 1 is an isometric exploded view of an electric motor.

FIG. 2 is an isometric exploded view of an electric motor.

FIG. 3 is an isometric cross-sectional view of an electric motor.

FIG. 4A is an isometric view of a phase assembly of an electric motor.

FIG. 4B is an enlarged isometric view of a portion of the phase assembly.

FIG. 4C is a cross-sectional view taken along line C-C in FIG. 4A.

FIG. 5A is an isometric view of a laminate sheet.

FIG. 5B is an isometric view of a flux ring assembled from the laminate sheets shown in FIG. 5A.

FIG. 6A is an elevational end view of a laminate sheet.

FIG. 6B is an isometric view of the laminate sheet shown in FIG. 6B bent for assembly into a flux ring.

FIG. 6C is an isometric view of a flux ring formed by multiple of the laminate sheets shown in FIG. 6A.

FIG. 7A is an elevational end view of a laminate sheet.

FIG. 7B is an exploded cross-sectional view of a portion of a phase assembly.

FIG. 7C is a cross-sectional view showing the phase assembly of FIG. 7B in an assembled state.

FIG. 8A is an isometric view of a laminate roll.

FIG. 8B is an isometric view of a laminate stack.

FIG. 8C is an isometric view of a portion of a phase assembly during a first assembly state.

FIG. 8D is an isometric view of the portion of the phase assembly shown in FIG. 8C during a second assembly state.

FIG. 8E is an enlarged cross-sectional view showing a phase assembly and portion of a rotor.

FIG. 9 is an enlarged cross-sectional view of a portion of a phase assembly.

FIG. 10 is an enlarged cross-sectional view showing a portion of a phase assembly and a portion of a rotor.

FIG. 11 is an isometric, cross-sectional view of a fan system including an electric motor.

### DETAILED DESCRIPTION

The present disclosure concerns electric motors. The main type of motor presented herein is a transverse flux motor, which is distinguished from axial or radial flux type electric motors. However, the inventive aspects discussed herein can be applied to various types of motors beyond just transverse flux motors. It is understood that, while electric machines of this disclosure are generally discussed as being an electric motor, the principles discussed herein are applicable to other electric machines, such as generators.

The electric machines of this disclosure include a rotor rotatable about a rotor axis and a stator configured to drive rotation of the rotor. According to aspects of the disclosure, the stator of the transverse flux electric machine includes stator phases, such as one, two, three, or more, formed from flux rings and a coil disposed axially between opposing flux rings. The flux rings include teeth that extend radially relative to the rotor axis and towards the rotor and extend axially over the coil to be disposed radially between the coil and the rotor. The flux rings are formed by stacked metallic sheets. The laminate sheets are stacked such that the terminuses of multiple ones of the laminate sheets are exposed to the air gap and oriented towards the rotor.

Several of the figures of the disclosure show a common axis, which is sometimes referred to as a motor axis. An axis of rotation of the rotor is disposed coaxially with the common axis. The term annular is used herein, which can refer to a ring shape (continuous or broken) about the common axis, which can be coaxial with the common axis. The term radial is used herein which when referring to a direction is any direction orthogonal to the common axis, unless otherwise noted. The term axial is used herein which when referring to a direction is any direction parallel with the common axis, unless otherwise noted. The terms circumferential or circumferentially as used herein means around the common axis, unless otherwise noted.

Components can be considered to radially overlap when those components are disposed at common axial locations along common axis CA. A radial line extending from common axis CA will extend through each of the radially overlapping components. Components can be considered to axially overlap when those components are disposed at common radial and circumferential locations such that an axial line parallel to common axis CA extends through the axially overlapping components. Components can be considered to circumferentially overlap when aligned about common axis CA, such that a circle centered on common axis CA passes through each of the circumferentially overlapping components.

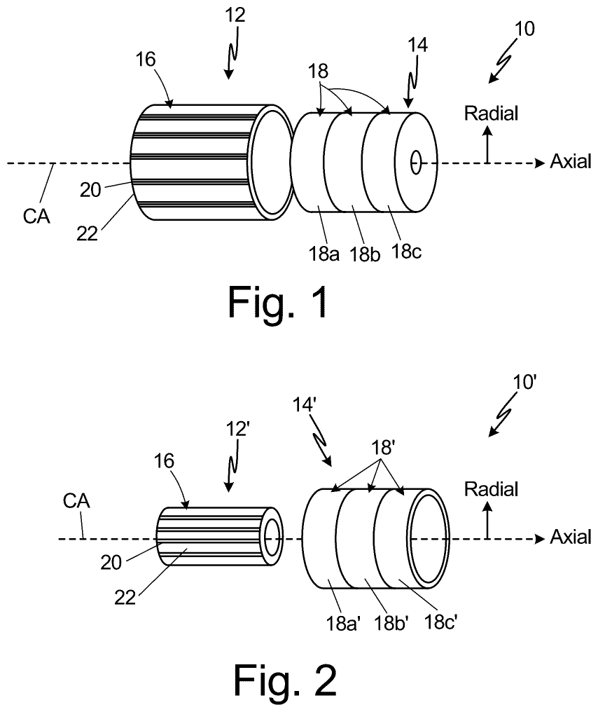

FIG. 1 is an isometric exploded block diagram of electric motor 10. Electric motor 10 includes rotor 12 and stator 14. Rotor 12 includes permanent magnet array 16. Stator 14 includes phase assemblies 18a-18c (collectively herein “phase assembly 18” or “phase assemblies 18”). In the example shown, permanent magnet array 16 includes permanent magnets 20 and concentrators 22.

In the example shown, rotor 12 is disposed radially outside of and about stator 14. In the example shown in FIG. 1, the rotor 12 and the stator 14 are separated, but it is understood that in operation the stator 14 is located radially inside of the rotor 12. Such a relationship is referred to as an outer rotator, being that the outer part of the electric motor 10 (the rotor 12) rotates relative to the inner part of the electric motor 10 (the stator 14). Both the rotor 12 the stator 14 are cylindrical and are orientated coaxial with each other along the common axis CA.

In the example shown, the stator 14 includes multiple phase assemblies 18. In particular, three phase assemblies 18a, 18b, 18c are shown. It is understood that a phase assembly 18 can alternatively be referred to as a stator phase. In coordination, but at different peak times, the phase assemblies 18 generate electromagnetic flux across an air gap disposed radially between the rotor 12 and the stator 14, which interacts with the permanent magnet array 16 of the rotor 12. Specifically, the electromagnetic flux interacts with the magnets 20 and concentrators 22 of the rotor 12. The magnets 20 and concentrators 22 are orientated in the axial direction. For example, a magnet 20 can extend the entire axial length of the rotor 12. The magnets 20 and concentrators 22 are interleaved to form the permanent magnet array 16 around the rotor 12.

FIG. 2 is an isometric exploded view of electric motor 10′. Electric motor 10′ includes rotor 12′ and stator 14′. Rotor 12′ includes permanent magnet array 16. Stator 14′ includes phase assemblies 18a′-18c′ (collectively herein “phase assembly 18′” or “phase assemblies 18′”). In the example shown, permanent magnet array 16 includes permanent magnets 20 and concentrators 22. In the example shown in FIG. 2, the rotor 12′ is configured to be located radially inside of the stator 14′. Such a relationship is referred to as an inner rotator, being that the inner part of the electric motor 10′ (the rotor 12′) rotates relative to the outer part of the electric motor 10′ (the stator 14′).

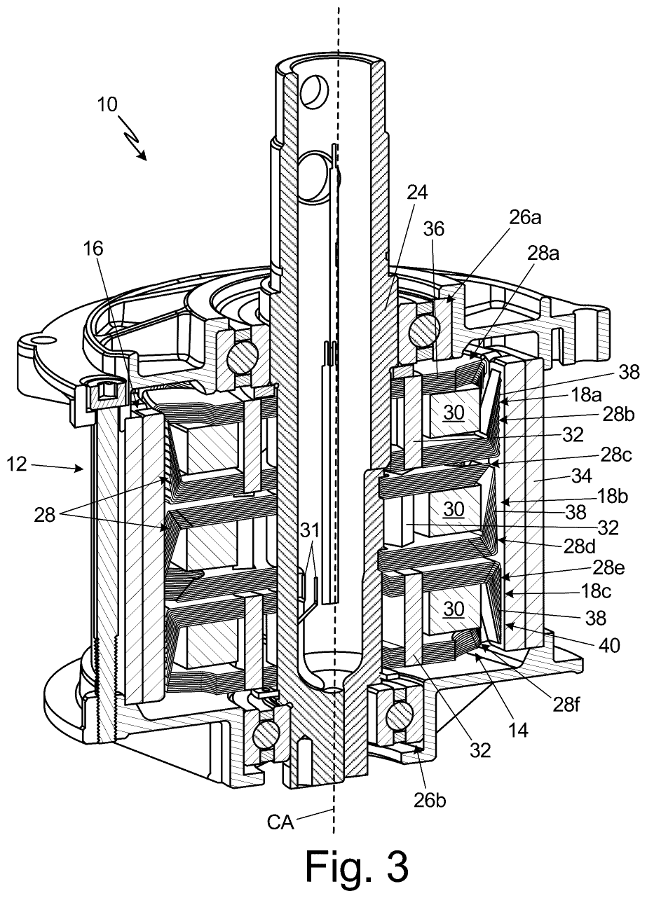

FIG. 3 is a cross-sectional view of an electric motor 10. Electric motor 10 includes rotor 12, stator 14, axle 24, and bearing assemblies 26a, 26b. Stator 14 includes phase assemblies 18 a-18c (referred to collectively herein as “phase assembly 18” or “phase assemblies 18”). Each phase assembly 18 includes flux rings 28, coil 30, and axial returns 32. Specifically in the example shown, phase assembly 18a includes flux rings 28a, 28b, coil 30, and axial returns 32; phase assembly 18b includes flux rings 28c, 28d, coil 30, and axial returns 32; and phase assembly 18c includes flux rings 28e, 28f, coil 30, and axial returns 32. Flux rings 28a-28f are referred to collectively herein as “flux ring 28” or “flux rings 28”. Rotor 12 includes permanent magnet array 16 and rotor body 34. Each flux ring 28 includes a ring body 36 and teeth 38.

Stator 14 is disposed coaxially with rotor 12 on the axis of rotation of rotor 12, which is coaxial with the common axis CA. Stator 14 includes phase assemblies 18 that are arrayed along and around the axis of rotation. Each phase assembly 18 includes a coil 30 extending circumferentially about the common axis CA. The phase assemblies 18 include metallic components formed on each axial side of the coil 30 of that phase assembly 18. Each phase assembly 18 includes metallic components formed on each radial side of the coil 30 of that phase assembly 18. The metallic components can be formed wholly or partially from stacks of laminations, which stacked laminate sheets can be referred to as a laminate stack. Laminations can be formed from material which is readily susceptible to polarization from the fields generated by coils 30. Such material is typically ferromagnetic. The ferromagnetic materials can be metal such as iron or an alloy of iron, such as steel. More specifically, laminations can be formed from silicon steel, among other options. Ferromagnetic material can be ceramic doped or otherwise embedded with ferromagnetic elements.

Various components of each phase assembly 18 can be formed from laminations having different stack orientations. In the example shown, flux rings 28 are formed from laminate sheets that are stacked axially and bent over coil 30 to be disposed radially between rotor 12 and coil 30. More specifically, teeth 38 are formed by portions of the laminate sheets that extend over the coil 30. As discussed in more detail below, the terminal portions of at least some of the laminate sheets are exposed to the radial air gap 40 between stator 14 and rotor 12. It is understood that the terminal portions of the laminate sheets can be considered to be exposed to the air gap 40 even if the teeth 38 are coated, such as by potting compound. The motor 10 does not include metallic components disposed radially between the teeth 38 and the permanent magnet array 16. In some examples, the motor 10 does not include any metallic components disposed radially between the terminal portions of each laminate sheet and the rotor 12. In the example shown, the laminate sheets are stacked such that an axial line through the laminate structure of a ring body 36 of the flux ring 28 extends through each sheet of the laminate stack.

The laminate structure of axial returns 32 is oriented transverse to the laminate structure of the ring bodies 36 of flux rings 28. In some examples, the laminate sheets of axial returns 32 are disposed orthogonal to the laminate sheets of the ring bodies 36 of flux rings 28. Axial returns 32 can be formed from laminate sheets stacked circumferentially and oriented axially. A tangent line to a circle centered on common axis CA and passing through a portion of an axial return 32 can extend through each sheet of the laminate stack of that axial return 32. In some examples, an arc extending circumferentially about common axis CA can pass through each sheet of the laminate stack of an axial return 32.

The coils 30 are formed as hoops of electrically conductive metal, such as copper among other options, that extend circumferentially about the common axis CA. The coils 30 are thus coaxial with the common axis CA. Each of the coils 30 is discrete with respect to the other ones of the coils 30. Each coil 30 is a winding of wire (e.g., round or ribbon strand), typically copper, around the common axis CA. Thus, each coil 30 could be a continuous winding of 20, 30, 40, 50, 100, or less or more loops around the common axis CA. Each coil 30 has two termination wires 31 (shown in FIG. 3), representing the ends of the circuit of each coil 30 for running an AC signal through the coil 30, which can electrically connect with a controller to control the AC signal through the coil 30.

The coils 30 of the multiple phase assemblies 18 do not radially overlap or cross over each other. No part of any one of the multiple coils 30 is disposed at the same axial location along the common axis CA as any other one of the coils 30. There is an axial gap between each of the coils 30 of the motor 10. The coils 30 are thus located at separate and distinct axial positions along the common axis CA. Each coil 30 is made as a circular loop with the common axis CA extending through each loop of each coil 30. The coils 30 do not include loops wherein the common axis CA does not extend through such loop. The material of the loops formed by coils 30 does not extend axially but instead extends circumferentially about the common axis CA.

Rotor 12 includes permanent magnet array 16 oriented towards stator 14. In the example shown, rotor 12 is disposed about stator 14 and permanent magnet array 16 is disposed on a radially inner side of rotor body 34. As such, motor 10 can be considered to include an outer rotator. Air gap 40 is disposed radially between stator 14 and rotor 12 such that stator 14 and rotor 12 are not in direct contact. More specifically, the air gap 40 is formed radially between a continuous matrix of potting compound of the stator 14 and permanent magnet array 16. It is understood, however, that in various other examples the rotor 12 is disposed within the stator 14 to rotate within the stator 14 such that motor 10 can be considered to include an inner rotator, similar to motor 10′ in FIG. 2. In such examples, permanent magnet array 16 can be disposed on an outer radial surface of rotor body 34.

Rotor 12 rotates on common axis CA and generates the rotational output. The permanent magnet array 16 is disposed on and supported by the rotor body 34 of rotor 12. The magnet array 16 can be formed by interspersed permanent magnets and concentrators. In some examples, the permanent magnet array 16 includes permanent magnets and does not include concentrators. The rotor 12 can be formed from neodymium and epoxy without laminate concentrators.

Axle 24 is disposed radially within rotor 12 and stator 14. Stator 14 is supported by axle 24. Each of bearing assemblies 26a, 26b are mounted on axle 24 such that rotor 12 can be considered to be rotatably supported by axle 24. Electrical connectors, such as wires, can extend to the phase assemblies 18 through axle 24.

Rotor 12 can be connected to a drive shaft (not shown) to rotate the drive shaft on the common axis CA. Rotor 12 can be directed connected to a driven component to drive that driven component. For example, the blade assembly, such as of a fan, can be directly connected to rotor 12 to be rotated by rotor 12, among other driven component options. Motor 10 can be configured such that the drive shaft completes one revolution for every one revolution of rotor 12. The direct drive relationship provides high responsiveness and a large speed range relative to traditional outputs having reduction gearing.

The phase assemblies 18 are electromagnetically polarized by coils 30 out-of-phase with respect to each other, such as 120-degrees electrically out-of-phase, to electromagnetically interact with the permanent magnet array 16 of rotor 12 to drive rotation of the rotor 12. While three stator phases 18 are shown herein, other embodiments may include a single phase, only two phases, or more than three phases.

Bearing assemblies 26a, 26b are disposed to support rotation of rotor 12. Bearing assemblies 26a, 26b can be of any desired configuration for supporting rotation of rotor 12 and axial loads experienced by motor 10. For example, bearing assemblies 26a, 26b can be ball bearings, roller bearings, etc. In the example shown, bearing assemblies 26a, 26b are disposed on opposite axial sides of stator 14 such that stator 14 is disposed fully axially between bearing assemblies 26a, 26b. The laminate structure of stator 14 is disposed fully axially between bearing assemblies 26a, 26b in the example shown.

A controller can be operably connected to motor 10, electrically and/or communicatively, to control operation of motor 10. For example, the controller can be operably connected to electrical components of stator 14 by wires extending through axle 24. The controller can be of any desired configuration for controlling operation of motor 10 and the rotational output of motor 10 (e.g., speed, torque, etc.) and can include control circuitry and memory. The controller is configured to store executable code, implement functionality, and/or process instructions. The controller is configured to perform any of the functions discussed herein, including receiving an output from any sensor referenced herein, detecting any condition or event referenced herein, and controlling operation of any components referenced herein. The controller can be of any suitable configuration for controlling operation, gathering data, processing data, etc. The controller can include hardware, firmware, and/or stored software. The controller can be of any type suitable for operating in accordance with the techniques described herein. It is understood that the controller can be entirely or partially disposed across one or more circuit boards. In some examples, the controller can be implemented as a plurality of discrete circuitry subassemblies.

During operation, power is provided to coils 30. Phase assemblies 18 generate electromagnetic fields that interact with the permanent magnet array 16 across air gap 40 to drive rotation of rotor 12. The embodiment of the motor 10 shown includes three phases corresponding to the three phase assemblies 18 and the coils 30 therein in which three sinusoidal AC signals are delivered through the coils 30 120-degrees electrically offset. If there were two phase assemblies 18 and two coils 30, then the two sinusoidal AC signals would be 180-degrees apart, or 90-degrees apart for sets of four phase assemblies 18, etc.

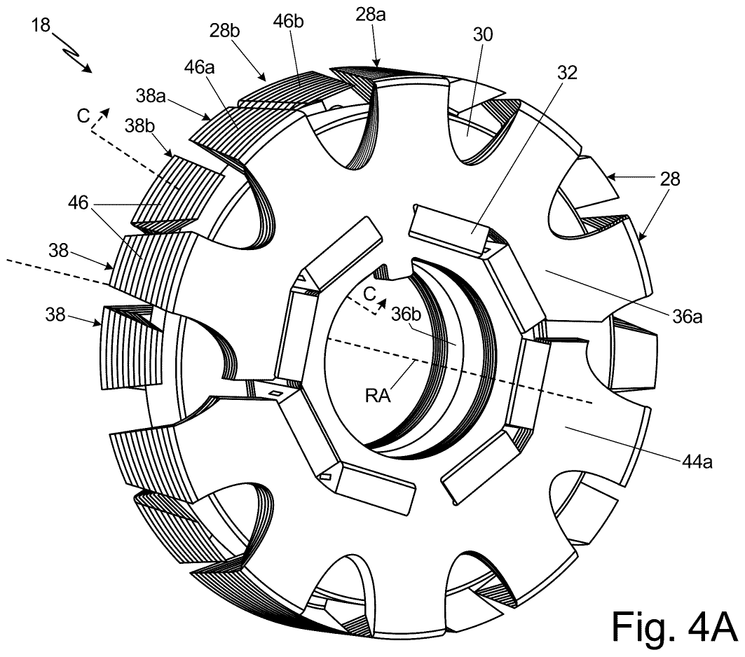

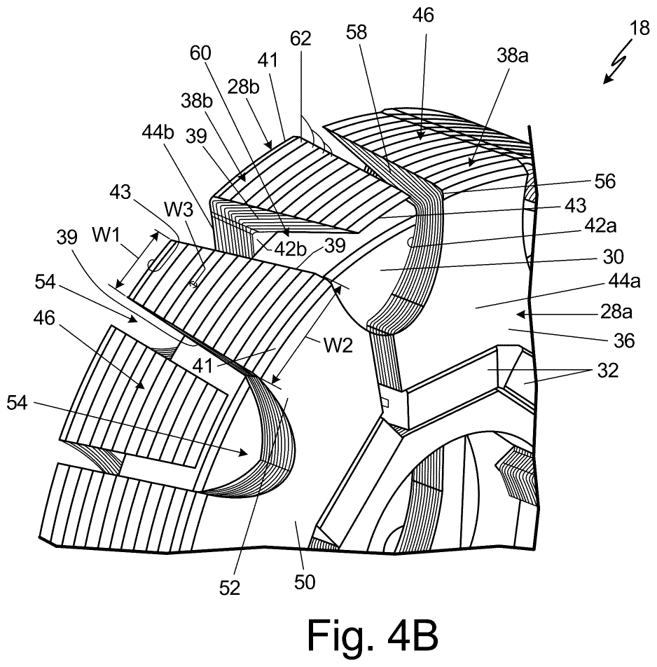

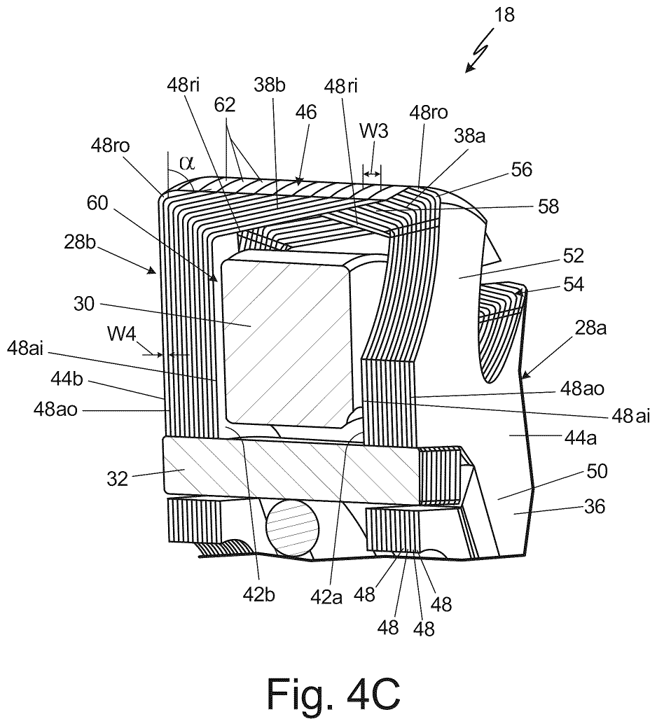

FIG. 4A is an isometric view of a phase assembly 18. FIG. 4B is an enlarged isometric view of a portion of phase assembly 18. FIG. 4C is a cross-sectional view taken along line C-C in FIG. 4A. FIGS. 4A-4C will be discussed together. Phase assembly 18 includes flux rings 28a, 28b (collectively herein “flux ring 28” or “flux rings 28”), coil 30, and axial returns 32. Flux rings 28a, 28b respectively include ring bodies 36a, 36b (collectively herein “ring body 36” or “ring bodies 36”); teeth 38a, 38b (collectively herein “tooth 38” or “teeth 38”); face sides 42a, 42b (collectively herein “face side 42” or “face sides 42”); and away sides 44a, 44b (collectively herein “away side 44” or “away sides 44”). Each tooth 38a, 38b respectively includes a tooth face 46a, 46b. Each flux ring 28 is formed by multiple laminas 48 stacked together to form the flux ring 28. Each lamina 48 includes a sheet body 50 and tabs 52 interleaved with troughs 54. Tabs 52 are formed to include a bend 56 and arm 58.

Flux rings 28 are disposed coaxially with respect to each other on axis RA, which is coaxial with the axis of rotation of the rotor 12 and thus also coaxial with the common axis CA. Flux rings 28 are oriented such that face sides 42a, 42b are oriented towards each other. Face sides 42a, 42b are each oriented towards coil 30. Face sides 42a, 42b face axially inward towards coil 30 such that coil 30 is bracketed between the face sides 42a, 42b. Away sides 44a, 44b are oriented away from coil 30. One or both of away sides 44a, 44b can be adjacent to an away side of another stator phase disposed adjacent to phase assembly 18, depending on the position of phase assembly 18 within the motor 10. Away sides 44 are oriented axially outward from phase assembly 18.

Ring bodies 36a, 36b extend annularly about the axis RA. Teeth 38a, 38b extend from ring bodies 36a, 36b, respectively, and are disposed radially over the coil 30. More specifically, teeth 38a are connected to ring body 36a, and teeth 38b are connected to ring body 36b. In the example shown, the laminas 48 forming the ring bodies 36a, 36b also form the teeth 38a, 38b. As such, teeth 38a, 38b are formed integral with ring bodies 36a, 36b, in the example shown. Axial returns 32 are disposed on an opposite radial side of coil 30 from teeth 38a, 38b.

Coil 30 is disposed directly between flux rings 28a, 28b and is bracketed by flux rings 28a, 28b. Coil 30 can be considered to be sandwiched directly between flux rings 28a, 28b. Coil 30 is disposed directly between the faces sides 42a, 42b of flux rings 28a, 28b. Coil 30 is disposed in an annular chamber 60 extending around the axis RA and centered on that axis RA. The chamber 60 is defined by laminas 48 on each of the inner and outer radial sides of the chamber 60 and on each of the axial sides of the chamber 60. Specifically in the example shown, the inner radial side of the chamber 60 is formed by the laminate sheets of axial returns 32 and the outer radial side and axial sides of the chamber 60 are formed by flux rings 28. More specifically, the outer radial side of the chamber 60 is formed by the portions of the laminas 48 forming the teeth 38 and the axial sides of the chamber 60 are formed by the portions of the laminas 48 forming the ring bodies 36. It is understood that in inner rotator examples the axial returns 32 can form the outer radial side of the chamber 60 and the teeth 38 can form the inner radial side of the chamber 60.

Other phase assemblies 18 of motor 10 can be identical to the phase assembly 18 shown in FIGS. 4A-4C, however, the other stator segments can be angularly offset about the rotational axis with respect to each other, such as by 120-degrees for a three phase electric motor. Such phases can be physically offset or electrically offset. The multiple phases can be physically offset by less than 120-degrees while still being 120-degrees electrically offset. The offset facilitates efficient, high torque operation of motor 10.

Each flux ring 28 is formed by stacked layers of metallic laminas 48. A single layer is referred to herein as a lamina or laminate sheet, while multiple stacked layers are referred to herein as laminas, laminate sheets, or a laminate stack. A preferred metal is steel, such as silicon steel. While steel is used herein as an example, it is understood that other types of flux concentrating/magnetically permeable metal can be used. The laminas 48 of each ring body 36 are stacked in the axial direction and such that the grain of the laminas 48 forming the ring bodies 36 is orientated in the radial direction. More specifically, each lamina 48 includes a sheet body 50 in which the grain of the lamina 48 is oriented in the radial direction. Tabs 52 extend from the sheet body 50 and are interspersed with troughs 54. In the example shown, tabs 52 are stacked to form the teeth 38. In the example shown, troughs 54 are disposed between adjacent ones of the tabs 52 of the same flux ring 28. In the example shown, tabs 52 include a radial portion that extends to a bend 56. Arms 58 extend both axially and radially from the bend 56.

Teeth 38 are formed by stacked laminas 48, as shown. In the example shown, each tooth 38 is formed by each of the laminas 48 of that flux ring 28. For example, each tooth 38a is formed by each lamina 48 of flux ring 28a. The laminas 48 of each tooth 38 are stacked so that the laminas 48 overlap both axially and radially. In the example shown, the teeth 38 are formed by the portions of the laminas 48 forming the arms 58. The grain of the laminas 48 forming the teeth 38 is oriented at a pitch that is offset, and not parallel to, both the axial direction and the radial direction. The pitches of the portions of the laminas 48 forming the teeth 38 are disposed at orientations transverse to both an axial line parallel to the axis RA and transverse to a radial line extending from the axis RA. The portions of the laminas 48 forming the teeth 38 are disposed at an acute angle α relative to the radial orientation of the sheet bodies 50 of the laminas 48.

The laminas 48 that form each tooth 38 can be the same laminas 48 that form the ring bodies 36. For example, the laminas 48 that form the first ring body 36a can also form each of the first plurality of teeth 38a. As such, the laminas 48 that form the first ring body 36a can be contiguous with the laminas 48 that form the first plurality of teeth 38a. Likewise, the laminas 48 that form the second ring body 36b can be contiguous with the laminas 48 that form the second plurality of teeth 38b. A single lamina 48 can form part of the first ring body 36a and part of each tooth 38a of the first plurality of teeth 38a. A single lamina 48 can form part of the second ring body 36b and part of each tooth 38b of the second plurality of teeth 38b.

To form flux rings 28a, 28b a stack of laminas 48 can be formed into a single, flat plate with radial extensions (e.g., tabs formed by the tabs 52), and then the extensions bent relative to the plate at angle α (e.g., 80-degrees or another angle less than 90-degrees) to form bends 56 and arms 58 and thus form the teeth 38a, 38b. In some examples, each lamina 48 can be formed as a flat sheet and then the tabs 52 bent to form bends 56 and arms 58. The laminas 48 with bends 56 and arms 58 can then be stacked to form a flux ring 28.

Similar to flux rings 28, axial returns 32 can be formed from stacked lamina. The lamina forming the axial returns 32 are stacked in the circumferential direction and such that the grain of the laminas of the axial returns 32 is oriented in the axial direction. The grain of the laminas of the axial returns 32 is transverse to the grain of the laminas 48 forming the flux rings 28. The grain of the laminas of the axial returns 32 can be orthogonal to the grain of the sheet bodies 50 of the laminas 48 forming the flux rings 28. The grain of the laminas of the axial returns 32 are transverse to the grains of the laminas 48 forming the teeth 38. In the example shown, the grain of the laminas of the axial returns 32 are transverse and non-orthogonal to each lamina 48 of each tooth 38a, 38b of both flux rings 28a, 28b.

With flux rings 28a, 28b positioned to form the phase assembly 18, the first teeth 38a are interleaved with the second teeth 38b about the axis RA. The first teeth 38a are axially aligned with the troughs 54 of flux ring 28b while the second teeth 38b are axially aligned with the troughs 54 of flux ring 28a. Teeth 38a, 38b are configured such that a portion of each tooth 38a, 38b overlaps circumferentially with the other teeth 38a, 38b of the pluralities of teeth 38a, 38b about the axis RA. The teeth 38a and teeth 38b circumferentially overlap such that a circle centered on the axis RA can be positioned to pass through each tooth 38a of the first plurality of teeth 38a and through each tooth 38b of the second plurality of teeth 38b. It is noted that the embodiment of FIGS. 4A-4C shows a phase assembly 18 configured for an outer rotator configuration in which the rotor 12 is spaced radially outward from and rotates around the phase assembly 18 of the stator 14 and such that the pluralities of teeth 38a, 38b are arrayed around the outer circumference of the stator 14 (and the phase assembly 18). However, in other configurations that include an inner rotator (e.g., as in FIG. 2), the pluralities of teeth 38a, 38b would be arrayed around an inner cylindrical cavity of the stator 14 within which the rotor 12 rotates. As such, teeth 38a, 38b would be disposed on an inner radial side of coil 30 and axial returns 32 are disposed on an outer radial side of coil 30, in inner rotator configurations.

Adjacent teeth 38a, 38b from the first plurality of teeth 38a and the second plurality of teeth 38b form flux pairs to generate a transverse orientated flux field which interacts with the permanent magnet array 16 of the rotor 12 across a stator-rotor air gap 40 to drive rotation of the rotor 12 with respect to the stator 14. The first plurality of teeth 38a form a first annular array of teeth 38 coaxial with the axis of rotation. The second plurality of teeth 38b form a second annular array of teeth 38 coaxial with the axis of rotation. The flux field is generated by running current through the coil 30. For example, a sinusoidal signal can be run through the coil 30. The reversing nature of the signal through the windings of the coil 30 builds and reverses the polarity between the adjacent pairs from the first plurality of teeth 38a and the second plurality of teeth 38b. The flux pairing of the circumferentially adjacent teeth 38a, 38b is facilitated by the axial returns 32 which form electromagnetic loops between the adjacent teeth 38a, 38b of the pair of flux rings 28a, 28b. Generally, flux flows with the grain of the laminas 48, along the direction of the laminate grain, as flux will generally follow the path of highest permeability and there is significant resistance to flux jumping from one layer of lamination to another layer of lamination. As noted above, the lamination grain along the teeth 38a, 38b is pitched such that the flux travels in a direction transverse to the radial and axial directions. The flux travels along the pitched laminate grain of the arms 58 to the radially-oriented laminate grain of the sheet bodies 50. The flux flow travels along the sheet bodies 50 to the axial returns 32. The laminate grain of the sheet bodies 50 is oriented radially while the lamination grain of the axial returns 32 is oriented axially such that the flux travels axially through the axial returns 32. The flux travels axially through the axial returns 32 and radially through the sheet bodies 50 around the coil 30. The teeth 38 project relative to sheet bodies 50 such that the flux flows transversely to the axial and radial directions through the teeth 38. In the example shown, the flux can be considered to flow helically through the teeth 38, ring bodies 36, and axial returns 32.

Each set of flux paired teeth 38a, 38b can form a pole, with multiple such pairs forming an array of poles circumferentially around the phase assembly 18. The poles interact with the permanent magnet array 16 of the rotor 12 to attract and/or repel the rotor 12 and thus drive rotation of the rotor 12. The first plurality of teeth 38a interleaved with the second plurality of teeth 38b, in which adjacent teeth 38a, 38b of first and second pluralities form flux pairs, form an annular array of poles between adjacent teeth 38a, 38b that is coaxial with the axis of rotation of the rotor 12. Each pole formed by flux paired teeth 38 magnetically pushes and/or pulls the permanent magnets 20 of the rotor 12 as they pass the paired teeth 38 during rotation, such that that annular array of poles are formed simultaneously, and which are all poled in the same orientation about the axis. Being that all the poles of this particular phase assembly 18 are activated by the single coil 30 of the phase assembly 18, the poles become polarized, and reverse their polarity, simultaneously. Such an arrangement and manner of operation results in a high pole count relative to radial or axial flux motors. Such high pole count is generated with less coils, a single coil 30 in the example shown, than radial or axial flux motors, simplifying operation and providing a smooth torque output from motor 10. The high pole count relative to the number of coils simplifies control requiring fewer signals from the controller to generate the high pole count, providing easier control and smoother operation of the motor 10.

Teeth 38 are formed such that each tooth 38 includes a tooth face 46 oriented towards the rotor 12. The tooth face 46 defines a surface of the tooth 38 that is oriented towards rotor 12. Generally, it is from the tooth face 46 that each tooth 38 magnetically interacts with the rotor 12 across the air gap 40 between the rotor 12 and the stator 14. The configuration of each tooth face 46 is important in concentrating flux at the tooth face 46 and supporting propagation of the flux across the air gap 40 to the rotor 12.

Teeth 38 are formed by multiple laminas 48. As shown, the laminas 48 forming the teeth 38 extend to terminuses 62. The terminuses 62 are disposed at the distal ends of the arms 58, opposite the end of the arm 58 at bend 56. The terminuses 62 are disposed along the tooth face 46. For each tooth 38, multiple ones of the terminuses 62 are arrayed along and form the tooth face 46.

It is at the terminus 62 of the lamina 48 that the flux concentration is particularly high. To support high flux concentration, the respective terminuses 62 of the laminas 48 are arrayed along the tooth face 46. In the example shown, the respective terminuses 62 of the laminas 48 are arrayed in the axial direction. The terminuses 62 can be considered to be stacked in the axial direction. As such, the terminuses 62 define an axial stack of laminas 48 at the tooth face 46. It is understood that, in some examples, a single outer lamina may cover the entire face 46 of the tooth 38 (e.g., in an embodiment where the grain of one or more laminas of the tooth 38, including the single outer lamina, are not pitched relative to the axial direction (i.e. are parallel with the axial direction). However, in such cases the radial-most lamina (e.g., the lamina 48 covering the entire tooth face 46) shields the portions of highest flux concentrations of the terminuses 62 of the other laminas 48 of the tooth 38 underneath the outermost lamina, thereby dampening flux concentration at the tooth face 46 and thus across the air gap 40 to the rotor 12. Various examples of the present disclose avoid such loss of performance by exposing the terminuses 62 of multiple, up to all, of the laminas 48 at the tooth face 46. Exposing the multiple laminas 48 at the tooth face 46 facilitates flux transfer across the air gap 40, requiring less power input to generate desired torque, providing of more efficient operation of the motor 10.

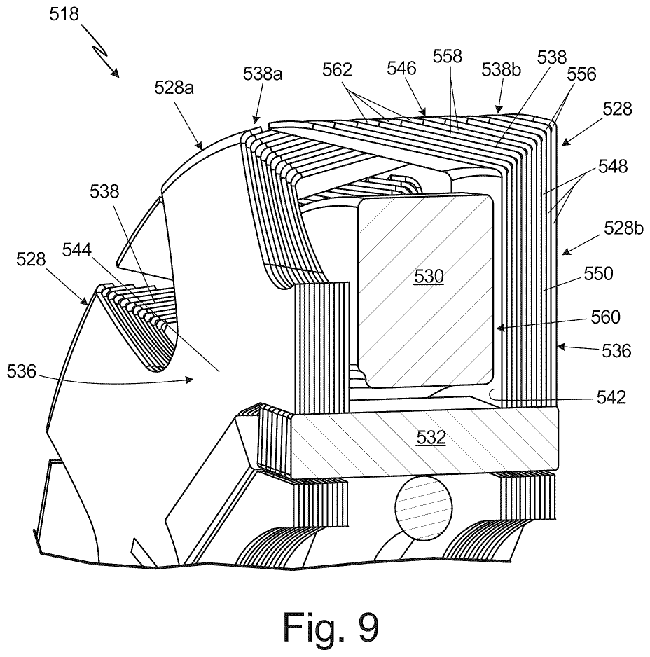

Terminuses 62 are oriented towards rotor 12 and form the metallic portion of the stator 14 closest to the air gap 40. In the example shown, each tooth face 46 is machined so that the tooth face 46 has a smooth surface profile despite being formed by the multiple terminuses 62 of multiple lamina 48. In the example shown, there are no steps or change in profile or diameter between the various terminuses 62, though it is understood that not all examples are so limited. The smooth profile along the tooth face 46 facilitates formation of a relatively small air gap 40 between the stator 14 and the rotor 12 as portions of the tooth face 46 do not project radially relative to other portions of the tooth face 46. The smaller the size of the air gap 40, the more efficient the flux transfer across the air gap 40. The smooth profile of the tooth face 46 facilitates efficient flux transfer and prevents losses. It is understood, however, that in various other examples (e.g., as best seen in FIG. 9), the terminuses 62 are configured to form a stepped surface profile in the axial direction instead of the smooth tooth face 46 shown.

Teeth 38 are configured such that teeth 38 narrow in the axial direction away from the ring body 36. Each tooth 38 has a first width W1 at a first axial end of the tooth 38 and a second width W2 at a second axial end of the tooth 38. The first width W1, which can be considered to be at the tip of the tooth 38 in the axial direction, is less than the second width W2, which can be considered to be at the root of the tooth 38 in the axial direction. The first width W1 and second width W2 can be considered to be circumferential widths that are measured one of about the axis RA and tangential to a circle centered on the axis RA. The teeth 38 and tooth faces 46 are tapered such that the circumferential sides 39 of the teeth 38 narrow from the tooth base 41 to the tooth tip 43. Teeth 38 taper along the axial extent of the tooth 38. Circumferential sides 39 converge as circumferential sides extend between tooth base 41 and tooth tip 43. In the example shown, circumferential sides 39 converge from tooth base 41 to tooth tip 43. The tapered configuration of the teeth 38 inhibits flux loss and leakage, providing for more efficient operation of the motor 10. The tapering maintains desired circumferential spacing between adjacent ones of the teeth 38a, 38b that form the flux pairs to inhibit the flux jumping between adjacent teeth 38.

The terminuses 62 of the laminas 48 of each tooth 38 are arrayed in the axial direction along the tooth face 46. The terminuses 62 of the laminas of each tooth 38 can be evenly arrayed along the tooth face 46 in the axial direction. The axial width W3 of each terminus 62 can be the same across the tooth face 46. Having multiple laminas exposed at the tooth face 46 and evenly arrayed along the tooth face 46 evenly distributes the flux concentrations along the tooth face 46, providing for more efficient operation of electric motor 10.

The laminas 48 forming the teeth 38 are pitched such that the lamina grain along each tooth 38 is neither parallel to nor orthogonal to either of the axial and radial directions. The pitched configuration of the laminas 48 positions the laminas 48 such that the terminuses 62 of the one or more of the laminas 48 exposed at tooth face 46 have the axial width W3 (which is a width measured in the axial direction). The axial width W3 at the terminuses 62 is larger than the width W4 of the lamina taken orthogonal to the grain direction of the lamina 48. The width W4 can be considered to be a sheet width of the lamina 48. The larger axial width W3 as compared to the sheet width W4 exposes a larger surface area of each lamina to the air gap 40 as compared to the surface area on a plane taken orthogonal to the grain of the lamina 48 sheet. In some examples, the width W3 can be twice as large as the width W4 providing a 2:1 ratio, among other ratio options. The increased surface area of each lamina 48 exposed to the air gap 40 facilitates efficient flux transfer across the air gap 40. The enlarged surface areas of the terminuses 62 at the tooth face 46 facilitates efficient flux transfer, reducing losses and leakage. As such, less powerful permanent magnets are required to generate desired torque, reducing costs and simplifying the motor arrangement.

Being that the grain of the laminas 48 of the teeth 38 are pitched, the radially inner laminas 48 along the tooth 38 (forming the face sides 42) are longer and the radially outer laminas 48 along the tooth 38 (forming the away sides 44) are shorter along each tooth 38, with the radially innermost lamina 48 being the longest and the radially outermost lamina 48 being the shortest. In FIG. 4B, the radially innermost one of lamina 48 is indicated as lamina 48ri and the radially outermost one of lamina 48 is indicated as lamina 48ro. More specifically, the laminas 48 are configured such that the arms 58 of the laminas 48 are different lengths. The laminas 48, in the example shown, are configured such that the laminas 48 have the same size and configuration in the sheet body 50, where the grain is radial, but the laminas 48 have different lengths and configurations along the arms 58, where the grain is pitched. For example, the arms 58 of the laminas 48 are differently configured in that each arm 58 has a different circumferential width at the terminus 62 of that arm 58 as compared to adjacent ones of the arms 58, providing the tapered configuration of each tooth 38. It is understood that, if phase assembly 18 were for an inner rotator configuration, the arrangement would be reversed such that the radially inner laminas would form the away sides 44 and be longer that the radially outer laminas that form the face sides 42, along each tooth 38.

Being that the grain of the laminas 48 of the teeth 38 are pitched, the portions of the axially innermost laminas 48 of the flux ring 28 that form the teeth 38, which laminas 48 also form the face sides 42, are larger than the portions of the axially outermost laminas 48 that form the teeth 48, which laminas 48 also form the away sides 44. Specifically, the arm 58 extending from the axially innermost lamina 48 is the longest of the arms 58 and the arm 58 extending from the axially outermost lamina 48 is the shortest of the arms 58. In FIG. 4B, the axially innermost one of lamina 48 is indicated as lamina 48ai and the axially outermost one of lamina 48 is indicated as lamina 48ao.

The phase assembly 18 shown in FIGS. 4A-4C is configured for use in an outer rotator. In outer rotator examples, the radially outermost lamina 48 of the teeth 38 is also the axially outermost lamina; similarly, the radially innermost lamina 48 of the teeth 38 is also the axially innermost lamina 48. It is understood, however, that in inner rotator examples the radially outermost lamina 48 of the teeth 38 is also the axially innermost lamina 48, as the radially outermost lamina 48 is closest to the coil 30 and furthest from the rotor 12 in inner rotator examples. Similarly, the radially innermost lamina 48 of the teeth 38 is also the axially outermost lamina 48, as the radially innermost lamina 48 is closest to the rotor 12 and furthest from the coil 30 in inner rotator examples.

Phase assembly 18 provides significant advantages. Phase assembly 18 is formed by opposed flux rings 28a, 28b that are formed by stacked laminas 48. The teeth 38a, 38b of the flux rings 28a, 28b extend over the coil 30 and form flux pairs to drive rotation of the rotor 12 relative to the stator 14. The teeth 38 are formed such that multiple ones of the stacked laminas 48 are exposed at the tooth face 46. The axially-stacked terminuses 62 of those laminas 48 facilitate efficient flux transfer across the air gap 40, providing increased torque, responsiveness, and efficiency relative to motors having a single lamina exposed at the air gap. In the example shown, each of the laminas 48 forming the flux ring 28 are exposed at the tooth face 46, facilitating efficient flux transfer. The axially-stacked laminas 48 further facilitate tapering of the teeth 38 between the tooth root and the tooth tip. Such tapering is not possible in motors that have laminas stacked in the circumferential direction because tapering such circumferentially-stacked laminas would decrease the amount of the laminas exposed to the air gap by progressively cutting off the outermost laminas to form the taper. The lack of a taper in such circumferentially-stacked laminas generates losses and flux leakage.

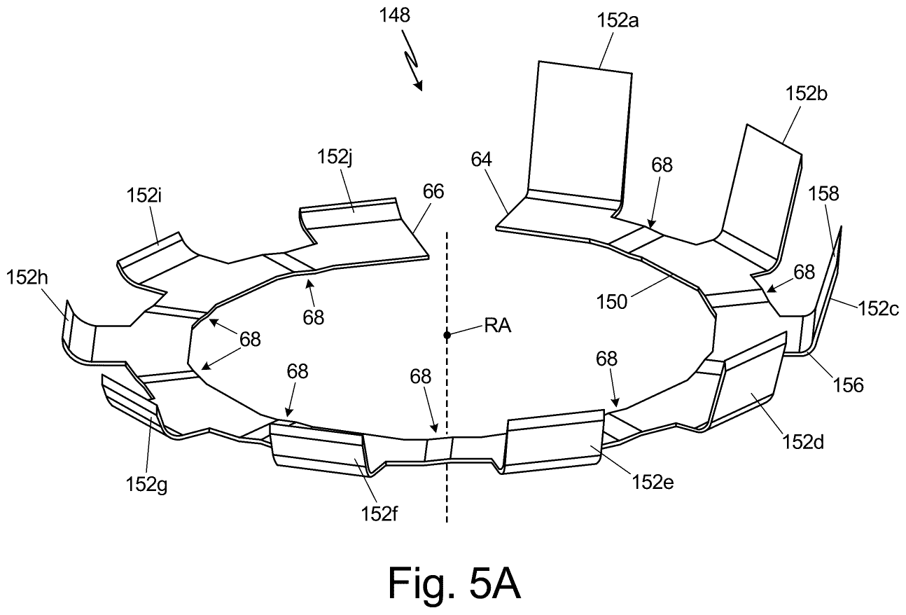

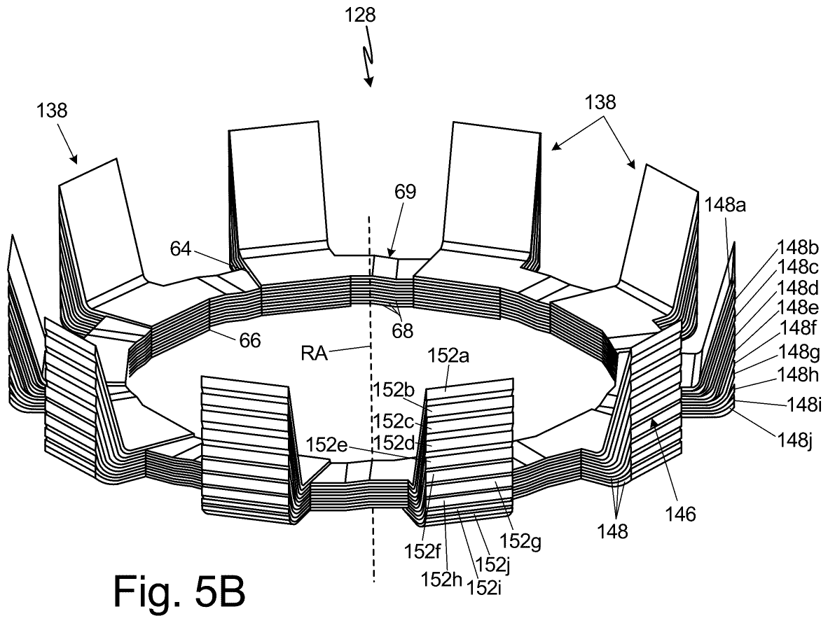

FIGS. 5A and 5B illustrate a process by which a flux ring 128 with integrated teeth 138 can be formed from multiple laminas 148. FIG. 5A is an isometric view of a single lamina 148. FIG. 5B is an isometric view of a flux ring assembled from multiple of the laminas 148 shown in FIG. 5A. FIGS. 5A and 5B will be discussed together. Each lamina 148 includes sheet body 150 and tabs 152. In the example shown, lamina 148 includes tabs 152a-152j, though it is understood that other tab counts are possible. Tabs 152a-152j are referred to collectively herein as “tab 152” or “tabs 152”.

Flux ring 128 and components thereof are substantially similar to flux ring 28 and components thereof (best seen in FIGS. 4A-4C), with reference numbers of similar components increased by “100.” Flux ring 128 is configured to form one of the flux rings of a phase assembly, such as a phase assembly 18. Multiple phase assemblies can be formed utilizing the same flux rings 128 and assembled together to form the stator 14 of electric motor 10. As such, a stator 14 can be formed by multiple flux rings having the same configuration.

Sheet body 150 extends between a first circumferential end 64 and a second circumferential end 66. Sheet body 150 is formed as an annular split ring. Tabs 152 extend from a radial side of sheet body 150. Transitions 68 are formed on sheet body 150. Transitions 68 are formed such that portions of sheet body 150 are disposed at different axial locations relative to each other. As such, first circumferential end 64 of sheet body 150 is axially offset from second circumferential end 66 of sheet body 150. Transitions 68 are disposed circumferentially between adjacent ones of the tabs 152. Transitions 68 facilitate helically stacking together multiple of lamina 148 to form flux sheet body 150, as discussed in more detail below.

In the example shown, tabs 152 extend from an outer radial side of sheet body 150. It is understood, however, that tabs 152 can extend from an inner radial side of sheet body 150 in inner rotator examples. Tabs 152 extend both axially and radially relative to sheet body 150. Each tab 152 projects in the same axial direction away from sheet body 150. In the example shown, tabs 152 are formed with a first portion extending from the sheet body 150 and a second portion extending from the first portion. The first portion can extend radially from the sheet body 150. The second portion can be pitched to extend both axially and radially from the first portion. The second portions can be considered to form the arms 158 of the laminas 148 and bends 156 are formed at the intersections of the first and second portions. The sheet body 150 portion of lamina 148 is configured to form a portion of the ring body 36 of the flux ring 128 while each tab 152 of the lamina 148 is configured to form a portion of a tooth 138 of the flux ring 128.

Laminas 148 can be initially formed as a sheet with unbent tabs 152. In some examples, the tabs 152 can initially have the same or similar lengths. The bends 156 can be formed by forcing the lamina 148 into a die, which causes bending of the tabs 152 at particular radial locations along each tab 152. The tabs 152 can be trimmed if needed, such as to form each tab 152 as a different length, with the tabs 152 being longer or shorter in graduated clock positions (i.e. adjacent tabs 152 are of next larger or smaller size, except for two adjacent tabs 152 which represent the longest and shortest tabs 152).

In the example shown, lamina 148 includes a plurality of tabs 152 arrayed circumferentially around the sheet body 150. The tabs 152 project radially outward in the outer rotator example shown, though it is understood that tabs 152 can project radially inward in inner rotator examples. The tabs 152 are configured such that each tab 152a-152j has a different axial length, which is the length in the axial direction rather than along the arm 158 itself. More specifically, the tabs 152 are configured to have progressively shorter axial lengths about sheet body 150. In the example shown, tab 152a has a longest axial length, tab 152j has a shortest axial length, and tabs 152b-152i each having progressively shorter axial lengths from tab 152b to tab 152i. Tab 152a is the tab 152 disposed closest to first circumferential end 64 and tab 152j is the tab 152 disposed closest to the second circumferential end 66. One of tabs 152a, 152j forms the initial tab of the array of tabs 152 of lamina 148 and the other one of tabs 152a, 152j forms the terminal tab of the array of tabs 152 of lamina 148.

Multiple of laminas 148 are assembled together to form the flux ring 128, as shown in FIG. 5B. Each of the laminas 148 forming the flux ring 128 can be identical such that only a single part (e.g., the lamina 148 shown in FIG. 5A) needs to be designed to form each of the laminate sheets of the flux ring 128. In the example shown in FIG. 5B, flux ring 128 is formed by laminas 148a-148j. The lamina count of the number of laminas 148 forming the flux ring 128 is the same as the tooth count of the number of teeth 138 of the flux ring 128, in the example shown.

The laminas 148a-148j are stacked together such that each lamina 148 forming the flux ring 128 is circumferentially offset relative to the other laminas 148 forming the flux ring 128. The laminas 148 are clocked about the ring axis RA, which is coaxial with the axis of rotation and common axis with flux ring 128 assembled into a stator. The laminas 148 are circumferentially offset such that each adjacent laminate 148 is misaligned by one tab indexing position. For example, the tab 152a of a first lamina 148a is aligned with a tab 152b of a second lamina 148b, tab 152a of the first lamina 148a is aligned with tab 152c of a third lamina 148c, etc. such that each of those aligned tabs 152 form a single tooth 138. As such, the longest tab 152 each lamina 148 is aligned with the second longest tab 152 of a second lamina 148 directly adjacent to the first lamina 148, which second longest tab 152 is aligned with a third longest tab 152 of a third lamina 148 directly adjacent to the second lamina 148, etc. This process of clocking the laminas 148a-148j is repeated such that each tab index position has one tab 152 of each length. The stacks of tabs 152 form the teeth 138. The laminas 148a-148j of each stack can be pressed, staked, pinned, welded, glued, or fixed together in any desired manner.

The different lengths of each tab 152 facilitates a portion of each tab 152 being exposed at the tooth face 46 of each tooth 138 of the flux ring 128. In the example shown, laminas 148 are helically stacked to form flux ring 128. The laminas 148 are helically stacked and are circumferentially indexed relative to each other to form the flux ring 128. Transitions 68 facilitate the axial stacking of different length tabs 152 as each portion of the sheet body 150 that a tab 152 extends from is axially offset from each other portion of the sheet body 150 that a tab 152 extends from. The transitions 68 of the multiple laminas 148a-148j forming the flux ring 128 are axially aligned and stacked with flux ring 128 assembled together, forming transition portions 69 of the flux ring 128 itself. Each transition portion 69 is circumferentially bracketed by the first circumferential end 64 and the second circumferential end 66 of a lamina 148. As such, the transition portions 69 of the flux ring 128 are disposed in the circumferential gaps of the split ring of a lamina 148 of the flux ring 128.

A portion of each lamina 148 forms a radially innermost lamina of the flux ring 128, at the longest tab 152 (tab 152a in the example shown) of that lamina 148, and a portion of each lamina 148 forms a radially outermost lamina of the flux ring 128, at the shortest tab 152 (tab 152j in the example shown) of that lamina 148. The various tabs 152 between those longest and shortest tabs 152 form intermediate laminas between those innermost and outermost laminas. As such, while each tab 152 of a first lamina 148a is exposed at each tooth face 46 of the flux ring 128, terminuses of those tabs 152 are disposed at different axial positions along each tooth face 46.

Laminas 148 and flux ring 128 provide significant advantages. Multiple identical laminas 148 can be used to form each flux ring 128 of a stator 14. The identical laminas 148 mean that only a single part needs to be designed and manufactured to form each lamina 148 of the flux ring 128. Building flux ring 128 from the multiple identical laminas 148 reduces part count, decreases costs, and simplifies manufacturing. The laminas 148 are helically indexed to create the stack, requiring less tooling and stamping to form the flux sheet body 150. In addition, the varying lengths of the tabs 152 facilitates building the flux ring 128 such that the teeth 138 of the flux ring 128 have a plurality of laminas 148 exposed at the tooth face 46 and arrayed axially along the tooth face 46. Exposing the laminas 148 in an axial array along the tooth face 46 facilitates efficient flux transfer during operation of the motor 10.

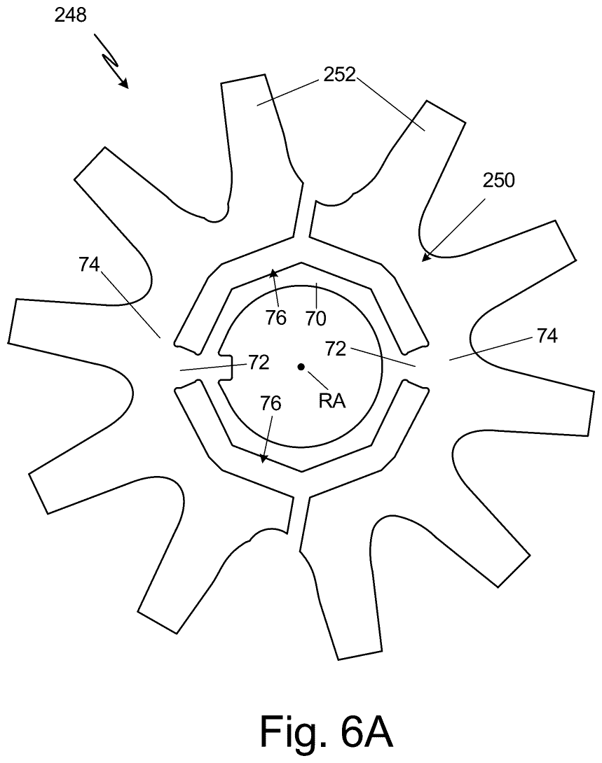

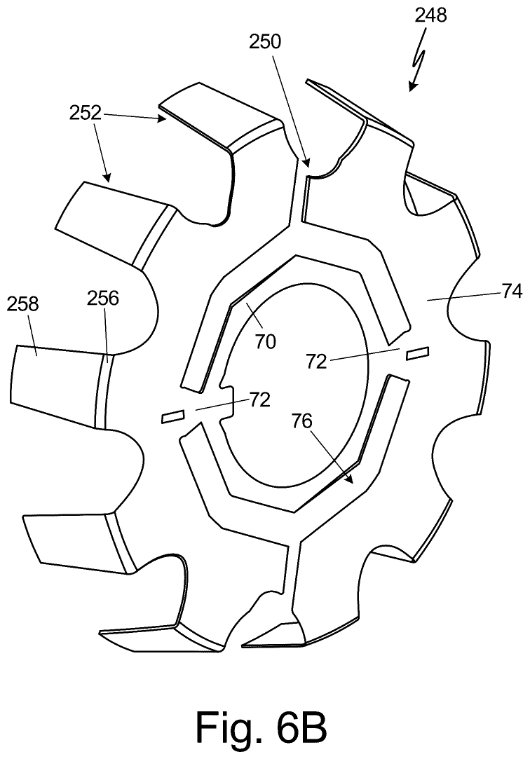

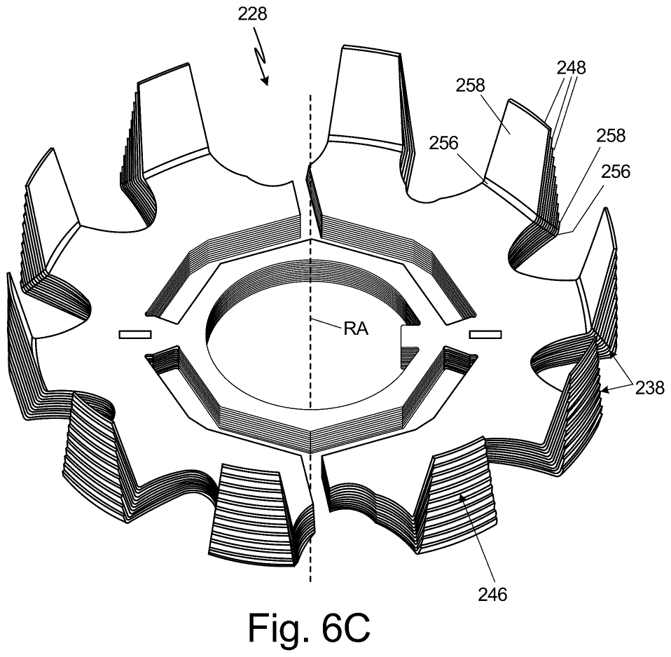

FIG. 6A is an isometric view of lamina 248. FIG. 6B is an isometric view of lamina 248 with bent tabs 252. FIG. 6C is an isometric view of flux ring 228 formed from laminas 248. FIGS. 6A-6C will be discussed together. Lamina 248 includes sheet body 250 and tabs 252. Sheet body 250 includes support ring 70, trunks 72, and branches 74. Flux ring 228 includes ring body 236 and teeth 238. Flux ring 228 and components thereof are substantially similar to flux ring 128 and components thereof (shown in FIGS. 5A and 5B) with reference numbers of similar components increased by “100.” Flux ring 228 and components thereof are substantially similar to flux ring 28 and components thereof (best seen in FIGS. 4A-4C) with reference numbers of similar components increased by “200.” Flux ring 228 is configured to form one of the flux rings of a phase assembly of a stator. Multiple phase assemblies can be assembled utilizing the same configuration of flux rings 228 and assembled together to form the stator 14 of an electric motor 10.

As shown in FIG. 6A, lamina 248 is initially formed in a flat configuration. In the example shown, lamina 248 can be considered to be star shaped. Sheet body 250 is formed annularly about the axis RA. Support ring 70 extends annularly fully about the axis RA. Trunks 72 project radially from the support ring 70 and branches 74 are connected to trunks 72. Gaps 76 are formed radially between the support ring 70 and the branches 74. Gaps 76 are configured to receive axial returns 32. Branches 74 are formed with multiple flat surfaces oriented radially inward and defining the outer radial sides of the gaps 76, which flat surfaces can interface with the axial returns 32.

Tabs 252 project radially from sheet body 250. In the example shown, tabs 252 project radially outward from sheet body 250. More specifically, tabs 252 project radially from the outer radial sides of branches 74. In the example shown, tabs 252 are commonly configured. In the example shown, each tab 252 extends the same radial length from the sheet body 250.

As shown in FIG. 6B, tabs 252 are bent at bends 256 to form arms 258. The tabs 252 are bent such that portions of tabs 252 are pitched relative to the axial direction along axis RA and relative to the radial direction extending from axis RA. Tabs 252 are bent at bends 256 to form arms 258 that are stacked together with arms 258 of other flux rings 228 to form teeth 238. A flux ring 228 can be formed from multiple of lamina 248 stacked together. In such examples, the tabs 252 of the multiple lamina 248 forming the flux ring 228 can be bent at different radial locations along the tabs 252 to have different arm lengths. For example, each of the lamina sheets forming flux ring 228 can be formed by the lamina 248 shown in FIG. 6A. Each of those multiple laminas 248 can then be configured for assembly by bending the tabs 252 at different radial locations along the tabs 252. A face side lamina 248 forming the laminate sheet at the face side 242 of flux ring 228 can have a bend 256 at a shortest radial distance from ring body 236 and an away side lamina 248 forming the laminate sheet at the away side 244 of the flux ring 228 can have a bend 256 at a longest radial distance from ring body 236, the radial distances being compared to the radial distances of the bends 256 for the other laminas 248 between the away side lamina 248 and the face side lamina 248. Each of the other lamina 248 of the flux ring 228 between the face side lamina 248 and the away side lamina 248 can have bends 256 at different radial locations relative to the ring body 236, progressing from radially-closer bends to radially-further bends from the face side lamina 248 to the away side lamina 248. The multiples ones of lamina 248 forming the flux ring 228 can thus have tabs 252 having different arms lengths as compared to other ones of the laminas 248 forming the flux ring 228.

As shown in FIG. 6C, flux ring 228 is formed by laminas 248 stacked one on top of another. In the example shown, the laminas 248 are stacked without clocking such that each lamina 248 is in the same rotational orientation about the axis RA. With laminas 248 aligned, the trunks 72 and branches 74 are axially aligned such that flux ring 228 also includes trunks and branches. The gaps 76 are aligned to form slots for receiving the axial returns 32. Laminas 248 are stacked such that multiple of the lamina 248 are exposed at the tooth face 246 of each tooth 238 of the flux ring 228. In the example shown, the laminas 248 are stacked such that each tooth face 248 has a stepped surface profile. The steps are arrayed axially. It is understood that the tooth faces 248, or the tips of the tabs 252 before assembly, can be machined to provide a smooth surface profile for each of the tooth faces 248, similar to tooth faces 48 (best seen in FIGS. 4B and 4C)

Laminas 248 provide significant advantages. A single configuration of lamina 248 can be design and manufactured to form each flux ring 228 of a stator. The tabs 252 of the commonly configured laminas 248 are bent at different radial locations to facilitate stacking and form the teeth 238 from the stacked lamina 248. The different arm lengths facilitate exposing the multiple lamina 248 at the tooth face 246. The commonly configured lamina 248 can be formed from a single stamping, significantly reducing manufacturing costs and time. Having only a single configuration of lamina 248 reduces part count, simplifying assembly and inventory management.

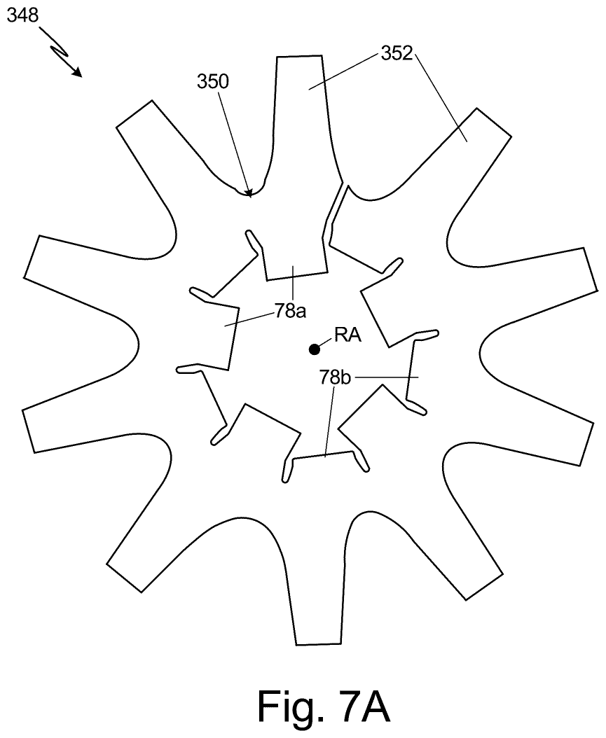

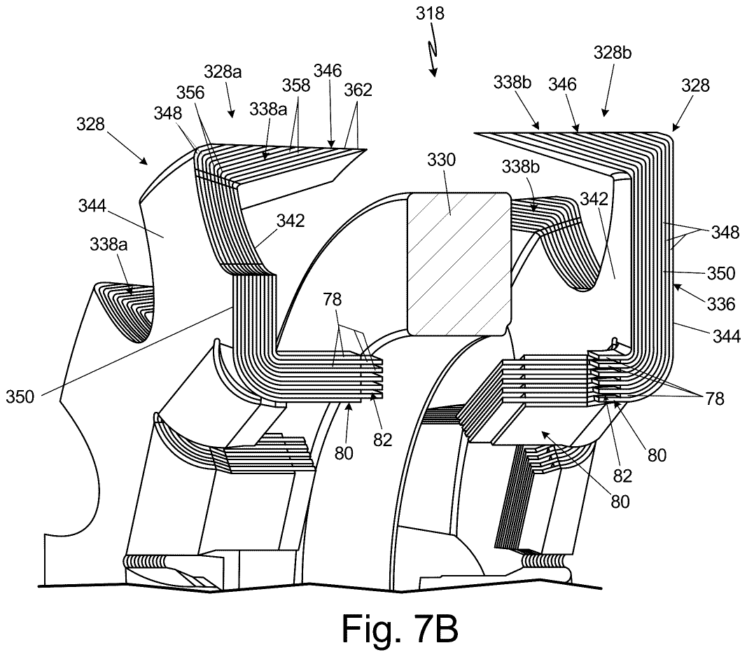

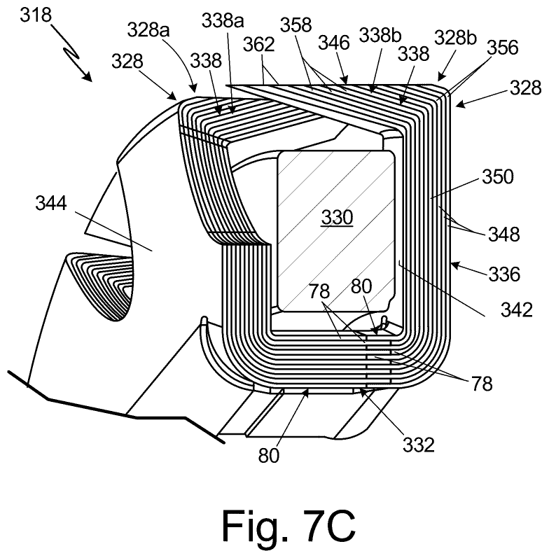

FIG. 7A is an elevational end view of a lamina 348. FIG. 7B is an enlarged cross-sectional exploded view of a portion of a phase assembly 318. FIG. 7C is an enlarged cross-sectional view showing the portion of the phase assembly 318 with flux rings 328a, 328b assembled together. FIGS. 7A-7C will be discussed together. Lamina 348 includes sheet body 350, tabs 352, and return tabs 78a, 78b. Phase assembly 318 includes flux rings 328a, 328b, coil 330, and axial return 332. Flux rings 328a, 328b can be referred to collectively as “flux ring 328” or “flux rings 328.” Phase assembly 318 is substantially similar to phase assembly 18 (best seen in FIGS. 3-4C) with reference numbers of similar components increased by “300”. Flux ring 328 and components thereof are substantially similar to flux ring 28 and components thereof (best seen in FIGS. 4A-4C) with reference numbers of similar components increased by “300.” Flux ring 328 and components thereof are substantially similar to flux ring 128 and components thereof (best seen in FIGS. 5A and 5B) with reference numbers of similar components increased by “200.” Flux ring 328 and components thereof are substantially similar to flux ring 228 and components thereof (best seen in FIG. 6C) with reference numbers of similar components increased by “100.”

Lamina 348 is initially formed in a flat configuration. In the example shown, lamina 348 can be considered to be star shaped. In the example shown, lamina 348 is dual-star shaped with multiple radial projections extending from both radial sides of sheet body 350. Sheet body 350 extends annularly fully about the axis RA. Tabs 352 project radially from a first radial side of sheet body 350. Return tabs 78a, 78b project radially from a second radial side of sheet body 350 opposite the first radial side of sheet body 350. In the example shown, tabs 352 extend from the outer radial side of sheet body 350 and return tabs 78 extend from the inner radial side of sheet body 350. As discussed in more detail below, return tabs 78 are configured to form axial returns 332 such that lamina 348 is configured for an outer rotator. It is understood, however, that tabs 352 can project from the inner radial side and return tabs 78 can project from the outer radial side in examples where lamina 348 is configured for an inner rotator.

Tabs 352 are configured to form portions of the teeth 338 of a flux ring 328. Tabs 352 are configured to be bent at bends 356 that are spaced radially from the sheet body 350 to form the arms 358 of the lamina 348, which arms 358 are stacked together to form the teeth 338. Tabs 352 are bent to have a pitched configuration such that arms 358 extend transverse to and non-orthogonal to the axial and radial directions. With tabs 352 bent, arms 358 extend both axially and radially from the sheet body 350 of lamina 348. The bent tabs 352 are stacked such that the terminuses 362 of the tabs 352 stack axially along the tooth face 346 to form the array of exposed lamina 348 along the tooth face 346 of each tooth 338.

Return tabs 78 are arrayed annularly about the ring axis RA. Return tabs 78a, 78b are configured such that return tabs 78a have a greater length that return tabs 78b. A tab length of return tabs 78a is longer than a tab length of return tabs 78b. The tab length can be taken prior to return tabs 78 being bent. In some examples, the return tabs 78a can have a longer axial length than return tabs 78b after bending. With lamina 348 in the flat sheet configuration shown in FIG. 6A, the return tabs 78a extend further radially from sheet body 350 than return tabs 78b. Return tabs 78a can be referred to as long tabs and return tabs 78b can be referred to as short tabs. The return tabs 78a, 78b are alternatingly arrayed about the axis RA such that each long return tab 78a is circumferentially bracketed by short return tabs 78b and such that each short return tab 78b is circumferentially bracketed by long return tabs 78a. Return tabs 78a, 78b are configured to form portions of the axial return 332 of the phase assembly 318. The axial return 332 is thus formed by metallic laminate sheets that also form the flux rings 328 and teeth 338. In the example shown, a single lamina 348 does not form both the teeth 338a and the teeth 338b, but each lamina 348 of the flux ring 328 forms at least one tooth 338, a sheet body 350, and at least a portion of an axial return 332. The alternating lengths of the return tabs 78a, 78b facilitates manufacturing of lamina 348 by a single stamping. The alternating lengths of the return tabs 78a, 78b allows for forming a portion of each axial return 332 integrally with the laminate of a flux ring 328.

Tabs 352 are bent to form the arms 358 of the lamina 348, and multiple of the laminas 348 are stacked together to form the teeth 338a, 338b. The return tabs 78a, 78b are bent to form portions of the axial returns 332. In the example shown, tabs 352 are bent such that the arms 358 are pitched to extend both axially and radially from the sheet body 350 portion of the lamina 348. Return tabs 78a, 78b are bent such that return tabs 78a, 78b extend axially. As such, a single lamina 348 can include laminate grain that is pitched such that the grain extends transverse to the axial direction and the radial direction (along the portions of the tabs 352 forming the teeth 338), can include laminate grain that extends radially (along sheet body 350 and, in some examples, along portions of the tabs 352 depending on the location of the bend 356), and can include laminate grain that extends axially (i.e., along the return tabs 78a, 78b). Unlike axial returns 32 that are formed by laminate sheets stacked circumferentially, axial returns 332 are formed by laminate sheets stacked radially. The configuration of flux rings 328 facilitates radially-stacked lamina forming the axial returns 332 as each of those radially-stacked lamina is in direct contact with the radially-oriented lamina of the ring bodies 336 of the flux rings 328. As such, the flux can travel through the teeth 338, ring bodies 336, and axial returns 332 without jumping between adjacent sheets, unlike examples where flux rings and axial returns are separately formed.

The tabs 352 and return tabs 78a, 78b of the lamina 348 shown in FIG. 7A are bent to the desired configuration for forming the teeth 338 and axial returns 332. Multiple lamina 348 are stacked together to form each flux ring 328. In one example, the laminas 348 are stacked such that long return tabs 78a are stacked together and short return tabs 78b are stacked together. The stacked return tabs 78 can be configured, during manufacturing or for assembly (such as by machining) to form return tabs 78 of different lengths, thereby forming grooves 82 within the stack of return tabs 78. The grooves 82 are formed radially between radially stacked return tabs 78. The stacked return tabs 78 form axial projections 80 that are assembled together to form the axial returns 332. In the example shown, each flux ring 328 includes long axial projections 80 alternating with short axial projections 80. The long axial projections 80 of a first flux ring 328a, 328b are aligned with the short axial projections 80 of a second flux ring 328a, 328b such that the long and short axial projections 80 mate to form the axial returns 332.

In some examples, the lamina 348 can be clocked by one return tab 78a, 78b position relative to an adjacent lamina 348 during stacking to form the flux ring 328. In such an example, the long return tabs 78a and the short return tabs 78b can alternate within the stack. The alternating stacking of the long return tabs 78a and the short return tabs 78b can form the axial projections 80 with grooves 82 disposed radially therebetween. In another example, laminas 348 can be formed in multiple configurations that are stacked together to form the flux rings 328. For example, a first configuration of lamina 348 can have first long return tabs 78a having a first length and first short return tabs 78b having a second length, while a second configuration of lamina 348 can have second long return tabs 78a having a third length and second short return tabs 78b having a fourth length. The first length can be shorter than the third length and the second length longer than the fourth length. As such, the first configuration can have the longest and shortest return tabs 78 while the second configuration can have intermediate lengths of return tabs 78. Lamina 348 having the first configuration can be alternatingly stacked with lamina 348 having the second configuration to form axial projections 80 and grooves 82.

The laminas 348 are stacked together to form the flux rings 328a, 328b. The flux rings 328a, 328b are axially aligned with each other, as shown in FIG. 7B, and then fit together to form the phase assembly 318 as shown in FIG. 7C. In the example shown, long ones of the axial projections 80 of one flux ring 328 mate with short ones of the axial projections 80 of the other flux ring 328. The return tabs 78 of one flux ring 328a, 328b fit within the grooves 82 between the return tabs 78 of the other flux ring 328a, 328b. The flux rings 328a, 328b can thus be considered to be joined at finger joints within the axial returns 332. The flux rings 328a, 328b are magnetically connected by abutting faces of the return tabs 78. The axially-oriented faces of the various return tabs 78 of the first flux ring 328a abut the axially-oriented faces of the return tabs 78 of the second flux ring 328b to form the flux circuit through phase assembly 318.

While flux rings 328a, 328b are shown as interfacing at finger joints, it is understood that flux rings 328a, 328b can interface in any desired manner suitable for magnetically connecting the flux rings 328. In some examples, the return tabs 78 are configured to interface at face joints. For example, the laminas 348 can be stacked such that axial projections 80 do not include grooves 82. The ends of the return tabs 78 can, in some examples, be aligned to form a flat face at the end of the axial projections 80. During assembly of phase assembly 318, a first flux ring 328 can be clocked one return tab position relative to the second flux ring 328 such that the long axial projections 80 of the first flux ring 328 are aligned with the short axial projections 80 of the second flux ring 328, and such that the short axial projections 80 of the first flux ring 328 are aligned with the long axial projections 80 of the second flux ring 328. The axial returns 332 are formed by the axial projections 80 meeting at the face joints. The axially-oriented faces of the stacks of long axial projections 80 abut the axially-oriented faces of the stacks of short axial projections 80. The face joints magnetically connect the flux rings 328a, 328b to form the flux circuit through phase assembly 318.

It is understood that lamina 348 can be formed having return tabs 78a, 78b of any desired configuration. In the example shown, the lamina 348 has return tabs 78a, 78b of differing lengths. However, some examples of lamina 348 can include return tabs 78 of the same or similar length such that return tabs 78a are the same length as return tabs 78b. In some examples, the laminas 348 can be assembled together to form the flux rings 328 and the return tabs 78 can be machined such that the axial faces of the return tabs 78 of an axial projection 380 are disposed in a common plane. In some examples, various ones of the return tabs 78a, 78b can be machined to different lengths after bending to account for length differences due to the different positions of the laminas 348 within the stack forming the flux ring 328, such as by machining so that the projecting return tabs 78a, 78b have axial faces disposed in a common plane. In some examples, the various return tabs 78 can be bent at different radial locations on different ones of the lamina 348 such that the axially-extending portions of the return tabs 78 have different lengths arrayed along the radial stack forming an axial projection 380. The projecting return tabs 78 can be machined to any desired length to facilitate assembly.

In some examples, the return tabs 78 can be configured such that the axial faces of the individual return tabs 78 are stacked in a stepped configuration arrayed along the radial stack of the axial projection 380. Flux rings 328 have face sides 342 oriented towards coil 330 and away sides 344 oriented away from coil 330. The return tab 78 of the away-side lamina 348 (the lamina 348 forming the away side 344) can be the longest tab and the return tab 78 of the face-side lamina 348 (the lamina forming the face side 342) can be the shortest tab. The mating flux ring 328 can be oppositely configured to facilitate mating of the flux rings 328 and formation of the axial return 332. In such an example, the return tab 78 of the face-side lamina of the mating flux ring 328 can be the shortest tab and the return tab 78 of the away-side lamina of the mating flux ring 328 can be the longest tab.

In the example shown, the return tabs 78 have flat axial face. For example, the axial faces of the return tabs 80 of first and second flux rings 328a, 328b can be machined such that the faces are pitched relative to the axial and radial directions to form first and second interface surfaces on the respective flux rings 328a, 328b. The respective interface surfaces are formed with opposed faces such that the interface surfaces abut. In one example, the axial faces of the first flux ring 328 are sloped such that the return tabs 78 are longer on the outer radial sides than on the inner radial sides and the axial faces of the second flux ring 328 are sloped such that the return tabs 78 are longer on the inner radial sides than on the outer radial sides, among other options. The opposing interface surface mate to form the flux path through the axial return 332.

The integral axial returns 332 formed by the same lamina 348 as other portions of the flux ring 328 provides significant advantages. In some examples, only a single configuration of lamina 348 needs to be manufactured and can be used to form each lamina 348 of the flux ring 328. Utilizing the single configuration reduces manufacturing costs and part count and facilitates easier assembly of phase assembly 318. The flux rings 328 are joined to form the phase assembly 318 such that only a single physical joint is formed in the flux circuit between the teeth 338a, 338b, which joint is at the interface between the axial projections 80 of the two flux rings 328. Such a configuration reduces the joint count, which can provide for more efficient flux transfer and thus more efficient motor operation. In addition, forming the axial returns 332 unitary with the flux ring 328 reduces part count and inventory, thereby reducing costs, and the unitary configuration can simplify manufacturing and assembly of the phase assembly 318, increasing efficiency and decreasing down time.

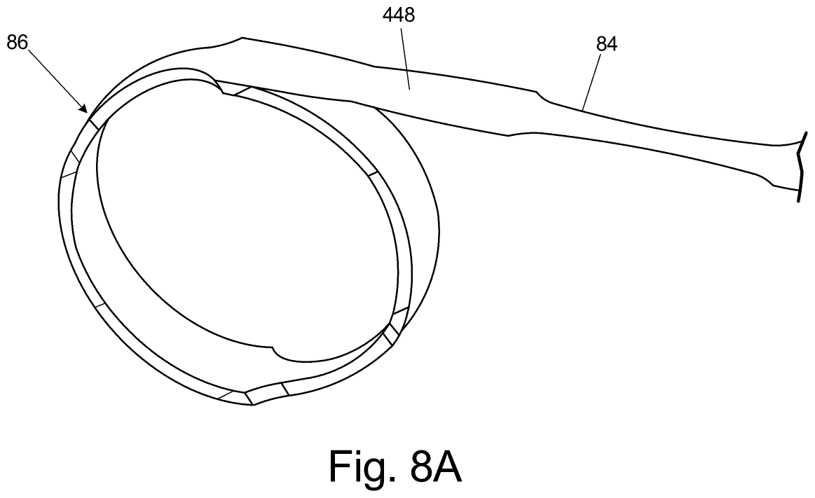

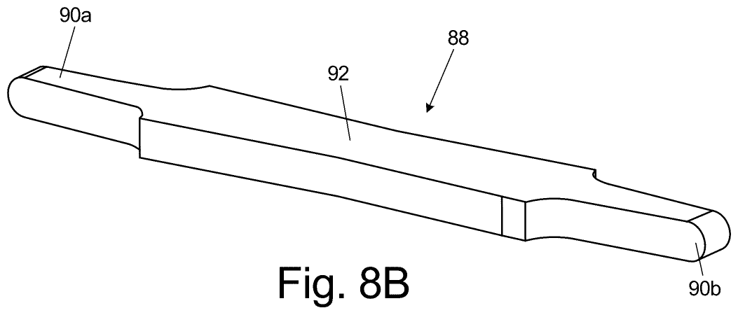

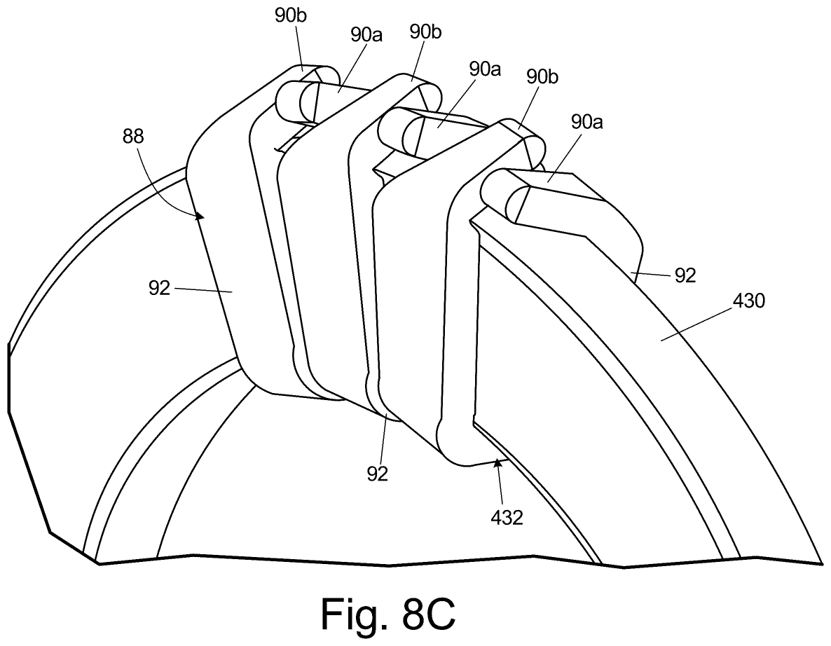

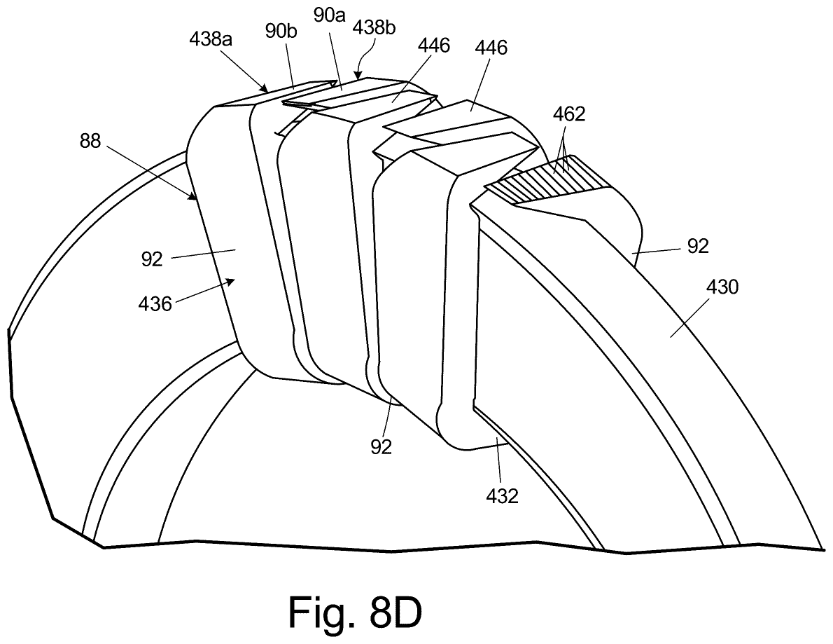

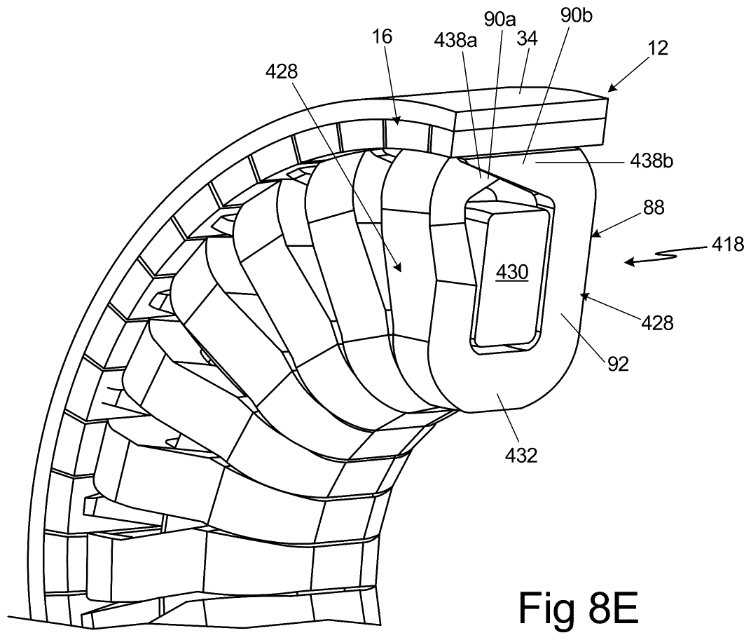

FIG. 8A is an isometric view of a laminate spool 86. FIG. 8B is an isometric view of a laminate rod 88, which includes rod ends 90a, 90b and rod body 92. FIG. 8C is an isometric view of a portion of a phase assembly 418 formed from laminate rods 88 of FIG. 8B. FIG. 8D is an isometric view of the portion of the phase assembly 418 of FIG. 8C in an assembled state. FIG. 8E is an enlarged cross-sectional view showing a phase assembly 418 and portion of a rotor 12 with rotor body 34 and permanent magnet array 16. FIGS. 8A-8E illustrate a method of forming teeth 438 having lamina terminations arrayed axially along the tooth face 446. FIGS. 8A-8E will be discussed together.

Lamina 448 is formed as laminate strip 84. As shown in FIG. 8A a laminate strip 84 is rolled in layers to form a layered laminate spool 86. The laminate spool 86 is formed from multiple layers of the laminate strip 84 stacked together by the rolling. The laminate strip 84 can be cut to a desired shape as the laminate strip 84 approaches the laminate spool 86, such as by laser cutting among other options. In some examples, the laminate spool 86 is shaped after being rolled, such as by machining once formed into the laminate spool 86 shown in FIG. 8A. The laminate spool 86 is rolled until a desired number of layers of the laminate strip 84 are stacked together to form the laminate spool 86. In this way, the laminate spool 86 can be formed by a single contiguous piece of lamina 448.

As shown in FIG. 8B, the laminate spool 86 is formed into a laminate rod 88. For example, the laminate spool 86 can be cut to form the laminate rod 88. In some examples, cutting the laminate spool 86 can form multiple stacks to form multiple laminate rods 88, such as two laminate rods 88 per laminate spool 86, though it is understood that other quantities are possible.

As shown in FIG. 8C, the laminate rod 88 is bent to assemble laminate rod 88 to form flux rings 428 and phase assembly 418. The bent laminate rod 88 is configured disposed around the coil 430. More specifically, the laminate rod 88 is bent such that rod body 92 wraps around the coil 430. The rod body 92 can be considered to extend around three sides of the coil 430 (the two axial sides and one radial side), in the example shown. Rod ends 90a, 90b are bent relative to rod body 92. Rod ends 90a, 90b are bent such that rod ends 90a, 90b are pitched. The rod ends 90a, 90b are pitched such that the lamina 448 forming the rod ends 90a, 90b has a grain oriented transverse to the axial direction and the radial direction. The laminate forming the rod ends 90 extends transverse to, but not orthogonal to, a radial line from the axis RA and to an axial line parallel to the axis RA. The laminate rod 88 is wrapped such that rod end 90a is circumferentially offset from rod end 90b. In some examples, the laminate strip 84 can be shaped prior to forming into laminate spool 86 such that laminate rod 88 is formed with one rod end 90a offset circumferentially relative to the other rod end 90b. The misaligned rod ends 90a, 90b facilitate bending and wrapping of the laminate rod 88 around the coil 430.

Multiple of the laminate rods 88 are assembled around coil 430 to form the flux rings 428 on both axial sides of the coil 430. Flux rings 428 differ from flux rings 28, 128, 228, 328 in that breaks are formed in the laminate structure of flux rings 428 between each adjacent axial return 432. The breaks are formed in the ring body 436 and disposed circumferentially between each laminate rod 88 wrapped about coil 430. In the example shown, the laminate structure of each flux ring 428 includes the same number of teeth 438 as circumferential breaks. The laminate structure of each flux ring 428 includes the same number of circumferential breaks as axial returns 432.

As shown in FIG. 8D, the rod ends 90a, 90b are manipulated to form teeth 438a, 438b extending over coil 430. In some examples, rod ends 90a, 90b can be machined to form the teeth 438a, 438b. The machining forms the tooth face 446 of each tooth 438a, 438b. In some examples, the laminate rod 88 can be formed such that the rod ends 90a, 90b include the manipulated tooth faces 446. The manipulation exposes the multiple layers of laminate strip 84 at the tooth faces 446. Terminuses 462 are formed on the tooth faces 446 and are arrayed axially along the tooth face 446. A single lamina 448 forms both of the flux paired teeth 438 and the axial return 432 extending between and connecting the flux rings 428. A single lamina 448 is disposed on both radial and both axial sides of coil 430 such that the single lamina 448 forms a fully surrounded portion of the annular chamber 460. A single laminate rod 88 can form the full laminate flux path between the flux paired teeth 438a, 438b. A single laminate rod 88 forms the lamina 448 of the teeth 438a, 438b, the lamina 448 of an axial return 432, and the lamina 448 of the ring body 436 connecting the teeth 438a, 438b and the axial return 432.

Rolling the laminate strip 84 into laminate spool 86 to form the laminate rods 88 provides significant advantages. The opposing teeth 438a, 438b that form flux pairs are formed form the same laminas 448, which laminas 448 also forms the axial return 432 connecting those teeth 438a, 438b, removing any joints and providing efficient flux transfer. In addition, the laminate strip 84 can be formed from any desired metal available as a ribbon, such as thin-gauge silicon steel or amorphous metals that are not suitable for stamping. For example, the metal forming the laminate strip 84 can be as thin as 1/1000 of an inch thick (about 25.4 micrometers thick). Such an arrangement facilitates constructing the laminate portions of the phase assembly 418 from materials typically not suitable for use because the material may be too thin to stamp. In addition, laminate rods 88 can be used to form phase assemblies for either inner rotator or outer rotator configurations. Such a configuration requires only a single lamina strip 84 to form both inner and outer rotators, simplifying manufacturing, reducing costs, and reducing inventory requirements.

FIG. 9 is an enlarged cross-sectional showing a portion of phase assembly 518. Phase assembly 518 includes flux rings 528a, 528b (collectively herein “flux ring 528” or “flux rings 528”), coil 530, and axial returns 532. Flux rings 528a, 528b respectively include ring bodies 536a, 536b (collectively herein “ring body 536” or “ring bodies 536”); teeth 538a, 538b (collectively herein “tooth 538” or “teeth 538”); face sides 542; and away sides 544. Each tooth 538a, 538b includes a tooth face 546. Each flux ring 528 is formed by a plurality of laminas 548 stacked together to form the flux ring 528. Each lamina 548 includes a sheet body 550, bend 556, and arm 558.

Phase assembly 518 is substantially similar to phase assembly 18 (FIGS. 4A-4C), except for the configuration of teeth 538a, 538b of phase assembly 518. In the example shown, the teeth 538 are configured such that the terminuses 562 of the laminas 548 are stepped across the tooth face 546. Flux rings 528 are disposed coaxially with respect to each other on the axis of rotation of the rotor 12. Flux rings 528 are oriented such that face sides 542 are oriented towards each other and towards coil 530 and away sides 544 are oriented away from coil 530.

Axial returns 532 interface with flux rings to form flux circuits. Axial returns 532 are disposed on an opposite radial side of coil 530 from teeth 538. Axial returns 532 are disposed in slots formed in the flux rings 528. Axial returns 532 magnetically connect the flux rings 528 to form the flux circuit through phase assembly 518. Coil 530 is disposed directly between face sides 542. Coil 530 is disposed in an annular chamber 560 defined radially between the axial returns 532 and the teeth 538 and defined axially between the flux rings 528.

Flux rings 528 are formed by stacked lamina 548. Arms 558 extend from bends 556 to form the pitched lamina grain of teeth 538. The laminate grain of the teeth 538 is pitched such that the grain extends transverse to both the axial and radial directions relative to the axis RA. Teeth 538a are connected to ring body 536a, and teeth 538b are connected to ring body 536b. In the example shown, the laminas 548 forming the ring bodies 536a 536b also form the teeth 538a, 538b. As such, teeth 538a, 538b in the example shown are formed integral with ring bodies 536a, 536b.

Each tooth 538 has a tooth face 546 formed on an opposite radial side of the tooth 538 from the coil 530. The tooth face 546 is oriented towards the air gap 40 and the rotor 12. The tooth face 546 is formed by terminuses 562 of the lamina 548 that are arrayed along the tooth face 546. The terminuses 562 are arrayed axially along the tooth face 546. In the example shown, the terminuses 562 are formed such that the tooth faces 546 have stepped surface profiles. The steps are arrayed axially along the tooth face 546. The steps are configured to terminate at the same radial distance from the axis RA such that each terminus 562 is disposed the same radial distance from rotor 12 across the air gap 40.

Teeth 538 are configured such that terminuses 562 of the lamina 548 project radially relative to the inwardly adjacent lamina 548 (i.e., the lamina 548 closer to coil 530). For example, a first lamina 548 forms the face-side lamina 548, which is closest to coil 530, and a second lamina 548 is immediately adjacent to that first lamina 548. Arm length is measured from the bend 556 to the terminus 562 along the pitch of the arm 558. The arm 558 of the first lamina 548 has a longest axial length of any of the arms 558 of the same tooth 538. The arm 558 of the first lamina 548 has a longest radial length of any of the arms 558 of the same tooth 538. The arm 558 of the first lamina 548 has a longest length between the bend 556 and terminus 562 taken along the arm 558, such that the length is taken in the grain direction of the arm 558. The arm 558 of the second lamina 548 has a second longest length of any of the arms 558 forming the tooth 538. The terminus 562 of the second lamina 548 is spaced axially from the terminus 562 of the first lamina 548. The terminus 562 of the second lamina 548 projects radially relative to the portion of the first arm 558 interfacing with and supporting the second arm 558.

The stepped configuration of the terminuses 562 exposes a large surface area of each arm 558 to the air gap 40. A portion of the outer surface (oriented away from coil 530) of each arm 558 is exposed along with the end face of each arm 558. The large surface area exposed to the air gap 40 facilitates efficient flux transfer to cause rotation of the rotor 12. The teeth 538 of the stator 14 are momentarily polarized by a respective coil 530 to magnetically interact (i.e. alternatively attract and repel) magnets of the rotor 12 across the air gap 40 to move the rotor 12 relative to the stator 14. In addition, the stepped configuration simplifies manufacturing and assembly.

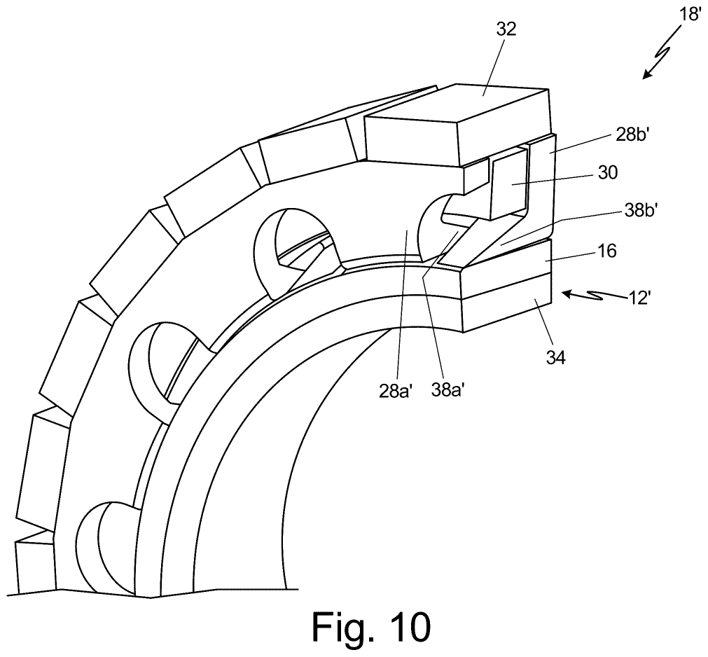

FIG. 10 is an enlarged cross-sectional view showing a portion of a phase assembly 18′ and a portion of a rotor 12′. Phase assembly 18′ and rotor 12′ are configured as an inner rotator. Phase assembly 18′ includes flux rings 28a′, 28b′ that include teeth 38a′, 38b′, respectively. The rotor 12′ is disposed radially within the stator that the phase assembly 18′ forms at least a portion of. The teeth 38a′, 38b′ of phase assembly 18′ are oriented such that the tooth faces face radially inwards towards the rotational axis.

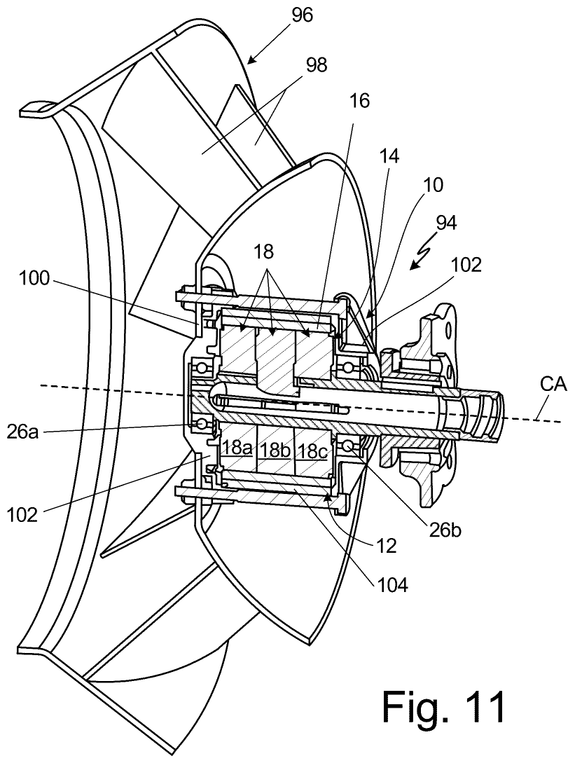

FIG. 11 is an isometric view of fan system 94. Fan system 94 includes motor 10 and blade assembly 96. Rotor 12 and stator 14 of motor 10 are shown. Blades 98 and fan hub 100 of blade assembly 96 are shown.

Motor 10 is an electric motor configured to generate a rotating mechanical output. In the example shown, motor 10 is configured to generate the output coaxially with common axis CA. Rotor body 34 encloses other components of motor 10, such as stator 14. Electric components of motor 10 are disposed, at least partially, within rotor body 34. In the example shown, rotor body 34 is includes end caps 102 connected together with a body cylinder 104 captured therebetween. The permanent magnet array 20 is mounted to the body cylinder 104. The end caps 102 ride on bearing assemblies 26a, 26b.

Blade assembly 96 is connected to motor 10 to be rotated by motor 10. In the example shown, motor 10 is an outer rotator such that rotor 12 rotates about stator 14. Rotor body 34 rotates with rotor 12 in the example shown. Blade assembly 96 is connected to rotor body 34 to rotate with rotor 12 on common axis CA. Blades 98 extend radially outward from fan hub 100. In the example shown, motor 10 and blade assembly 96 are disposed coaxially on common axis CA such that blades 98, fan hub 100, and rotor 12 rotate coaxially. In the example shown, blade assembly 96 is directly mounted to rotor 12 to rotate in a 1:1 relationship. Motor 10 thereby drives blade assembly 96 in a 1:1 relationship.

It is understood that, while fans are discussed, motors 10 according to the present disclosure can be utilized in any desired application and powering fans is only one such application. It is understood that any one or more aspects of motor 10 can be implemented in non-fan applications. Motor 10 can be configured for use in any desired electric motor assembly. It is thus understood that, while a fan is one implementation of the motor technologies presented herein, other applications, including non-fan applications, are possible and contemplated as within the scope of the disclosure. In examples where motor 10 does power a fan, it is understood that the blade assembly 96 can be disposed at any desired orientation and can be used to move any desired fluid, including gas and/or liquid.

While the electric machines of this disclosure are discussed in various contexts, it is understood that electric machines and controls can be utilized in a variety of contexts and systems and are not limited to those discussed. Any one or more of the electric machines discussed can be utilized alone or in unison with one or more additional electric machines to provide mechanical output from an electric signal input for any desired purpose. Further, while electric machines of this disclosure are generally discussed as being an electric motor, it is understood that electric machines of this disclosure can be of any desired form, such as a generator among other options.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A n electric motor comprising:
a rotor that rotates about an axis;
a coil extending about the axis; and
a first laminate rod formed from a plurality of stacked lamina and having a rod body, a first rod end, and a second rod end at an opposite end of the first laminate rod from the first rod end;
wherein the first laminate rod is wrapped around the coil such that the first laminate rod is disposed on a first axial side of the coil, a second axial side of the coil opposite the first axial side, a first radial side of the coil, and a second radial side of the coil opposite the first radial side.

2. The electric motor of claim 1, wherein the first rod end is disposed on the first radial side of the coil and the second rod end is disposed on the first radial side of the coil, the first rod end forming a first tooth and the second rod end forming a second tooth.

3. The electric motor of claim 2, wherein the first radial side of the coil is oriented away from the axis.

4. The electric motor of claim 2, wherein the first radial side of the coil is oriented towards the axis.

5. The electric motor of claim 2, wherein the first tooth circumferentially overlaps with the second tooth.

6. The electric motor of claim 1, wherein the first rod end includes a first tooth face oriented radially away from the coil and multiple first terminuses of the stacked lamina are exposed at the first tooth face.

7. The electric motor of claim 6, wherein the second rod end includes a second tooth face oriented radially away from the coil and multiple second terminuses of the stacked lamina are exposed at the second tooth face.

8. The electric motor of claim 1, wherein a first flux ring and a second flux ring of the phase assembly are formed by a plurality of the first laminate rods wrapped around the coil and extending annularly around the axis.

9. The electric motor of claim 1, wherein the first rod end circumferentially overlaps with the second rod end.

10. The electric motor of claim 1, wherein a plurality of the first laminate rods are wrapped around the coil.

11. The electric motor of claim 10, wherein a break is formed circumferentially between adjacent first laminate rods of the plurality of first laminate rods.

12. The electric motor of claim 1, further comprising:
a second laminate rod formed from a second plurality of stacked lamina and having a second rod body, a third rod end, and a fourth rod end at an opposite end of the second laminate rod from the third rod end;
wherein the second laminate rod is wrapped around the coil such that the second laminate rod is disposed on the first axial side of the coil, the second axial side of the coil, the first radial side of the coil, and the second radial side of the coil.

13. The electric motor of claim 12, wherein the first rod end is disposed directly circumferentially between the second rod end and the fourth rod end.

14. The electric motor of claim 13, wherein the first rod end forms a first tooth, the second rod end forms a second tooth, the third rod end forms a third tooth, and the fourth rod end forms a fourth tooth, and wherein each of the first rod end, the second rod end, the third rod end, and the fourth rod end are disposed on the first radial side of the coil.

15. A method of forming a laminate portion of a phase assembly of a stator of an electric motor, the phase assembly configured to be disposed coaxially on an axis with a rotor of the electric motor, the method comprising:
rolling a laminate strip into a laminate spool such that the laminate spool is formed by multiple layers of the laminate strip;
forming a laminate rod from the laminate spool; and
bending the laminate rod around a coil of the phase assembly such that the laminate rod is disposed on a first axial side of the coil, a second axial side of the coil opposite the first axial side, a first radial side of the coil, and a second radial side of the coil opposite the first radial side.

16. The method of claim 15, further comprising:
machining a first end of the laminate rod disposed on the first radial side of the coil and a second end of the laminate rod disposed on the first radial side of the coil to form tooth faces of teeth of the phase assembly.

17. The method of claim 15, wherein bending the laminate rod around the coil of the phase assembly such that the laminate rod is disposed on the first axial side of the coil, the second axial side of the coil opposite the first axial side, the first radial side of the coil; and the second radial side of the coil opposite the first radial side comprises:
bending a rod body of the laminate rod around the coil such that the rod body is disposed on the first axial side of the coil, the second axial side of the coil, and the second radial side of the coil;
bending a first end of the laminate rod relative to the rod body such that the first end of the laminate rod is disposed over the first radial side of the coil; and
bending a second end of the laminate rod relative to the rod body such that the second end of the laminate rod is disposed over the first radial side of the coil.

18. The method of claim 17, further comprising:
bending the laminate rod such that the second end of the laminate rod is spaced circumferentially from the first end of the laminate rod.

19. The method of claim 15, further comprising:
shaping the laminate strip prior to rolling the laminate strip into the laminate spool.

20. The method of claim 15, further comprising:
shaping the laminate strip as the laminate strip during rolling of the laminate strip into the laminate spool.
